(19) United States
(12) Patent Application Publication
(10) Pub. No.: US 2005/0203815 A1
(43) Pub. Date: Sep. 15, 2005

(54) Trust administration system and methods of use and doing business

(76) Inventors: Henry W. Abts III, Incline Village, NV (US); Christopher K. Abts, Reno, NV (US); Bruce C. Yates, Sparks, NV (US)

Correspondence Address: KLARQUIST SPARKMAN, LLP, 121 SW SALMON STREET, SUITE 1600, PORTLAND, OR, 97204, US

(21) Appl. No.: 11/031,422

(22) Filed: Jan. 7, 2005

Related U.S. Application Data
(60) Provisional application No. 60/535,124, filed on Jan. 7, 2004.
(60) Provisional application No. 60/560,625, filed on Apr. 9, 2004.

(51) Int. Cl. G06F 17/60

(52) U.S. Cl. 705/30

(57) ABSTRACT

An automated trust administration system and method of doing business. The trust administration system and method includes the ability to automatedly maintain trust asset data and update, revise, or transfer the data, including among one or more trusts, by ledger adjustment and verification. The system can automatedly issue third party notices and ensure compliance with applicable regional or federal laws, including tax laws. The system can also automatically generate tax return forms as needed, including tax return forms with data entry in them as required to comply with tax laws. The system can be used in conjunction with other trust recording and maintenance systems, and can provide or support methods of use and doing business through or in conjunction with trust administration, providing of trusts or trust related information or services, or other related activities or financial management services.

### CROSS REFERENCE TO RELATED APPLICATIONS

This specification claims priority through, and hereby incorporates by reference in their entirety, the applicants' prior provisional patent applications entitled “Trust Administration System and Methods of Use and Doing Business,” one of which was filed Jan. 7, 2004, Ser. No. 60/535,124, and the second of which was filed on Apr. 9, 2004, Ser. No. 60/560,625.

### COPYRIGHT NOTICE

Copyright 2003 by The Estate Plan, Inc. The copyright owner has no objection to copying of this patent specification solely for the purposes of patent specification review and analysis. All other copyrights reserved.

### BACKGROUND

The present invention relates to automated trust administration systems and methods of doing business using automated trust administration systems.

A trust is a legal entity by which one party—the trustee—controls assets and property of any form (also known as “principle” and “corpus”) that have been transferred to the trust by a person who establishes the trust. The “establishing” person is called the grantor (also settlor or trustor). Trust assets typically are invested or managed for the benefit of one or more beneficiaries. Often, title to trust assets can be distributed to the beneficiaries at a time identified in the trust or within the discretion of the trustee.

There are different types of trusts. One example is a living trust, which is established during the grantor's lifetime; another example is a testamentary trust, established in a will. An AB trust allows a married couple to pass the maximum amount of property to their children or other beneficiaries after both spouses die, while at the same time ensuring the surviving spouse receives benefits of assets in the trust during the surviving spouse's lifetime.

Common provisions in trusts include: the purpose of the trust; the names of the trust beneficiary or beneficiaries; the name of at least one trustee; the grantor's desires regarding how the trustee shall invest trust assets; when and under what conditions the trustee should disperse income from the trust to the trust's beneficiaries; and when the trustee should give full control of trust assets to the beneficiaries. Trust administration can present many formidable, time consuming, and costly task, often requiring significant expertise.

For example, the death of the grantor can involve administration of the transfer of title of trust assets to other trusts or beneficiaries. The trustee also often must prepare and file income tax returns and pay any taxes due from the trust, and the trustee also must often provide various types of legally required notices to various entities, such as beneficiaries or newspapers for publication of public notices. In addition, during the term of the trust, the trustee often must keeping accurate records of changes to the inherent value of trust assets such as through stock or real estate valuation changes or income earned by an asset; distributions made from trust assets to pay taxes or provide trust assets to beneficiaries for their use; and transfer of assets among trusts.

As a result, trust administration often involves maintaining a trust ledger showing the assets of the trust. A trust account ledger serves as a record of all trust money received (including money to be invested on behalf of the beneficiary), all disbursements made from the account, and the balance held in trust. The ledger also typically shows other valuable property received on behalf of a beneficiary. When trust assets change or are altered, such as by transferring assets into or out of a given trust or between trusts, the law has typically required that the administrator should (i) update the changes in the ledger as transfers in assets take place; (ii) contemporaneously generate and store separate asset transfer documents, and (ii) record or file asset transfer documentation with governmental entities.

Other challenges for trust administration include ensuring compliance with the differing trust laws and requirements among the several states. Because of the complexity and legalities involved, a trust administrator often retains a lawyer, accountant, or other expert familiar with the pertinent laws of the jurisdiction governing the trust and accounting procedures involved. If more than one trust is administered and each trust is in a different jurisdiction, lawyers or other experts from each different jurisdiction may be consulted.

Other complicating factors are the tax laws. The tax consequences of trust administration activities often require the employment of a tax lawyer or other expert to seek to remain in compliance with tax laws or regulations.

Yet another difficulty is the variety of forms generated in trust administration, often with the same information entered among differing forms. Examples of such data include the identity of the beneficiaries and their address, the identity of the trustee, and the name of the trust.

Other typically time consuming tasks can include paying debts of the grantor, closing credit accounts of the grantor, collecting on insurance policies, placing other assets in the trust, providing legal notices regarding the trust, the beneficiaries, or trust assets. Trust administration also may include many other challenges and tasks depending on the nature of the trust.

The trust administration industry has long been in need of tools and methods of administration to make these challenges and tasks easier to organize, record, and perform in compliance with the varying legal rules and regulations governing or relating to trusts and trust administration.

### BRIEF SUMMARY OF ASPECTS OF THE INVENTION

The present application is directed to a trust management system and methods of use and doing business. Aspects of the present trust management system and method of use and doing business include one or more of the following features:

a system ledger for automated transfer, management, and allocation of assets to and among trusts, and in certain embodiments: (a) without need for other asset transfer activity such as generation or recording of other title transfer documentation, or (b) in the asset allocation procedure, by limiting the ability to allocate or adjust allocations, in order to ensure that the allocation complies with rules governing asset allocation in the local of pertinent beneficiaries;

automate trust management, in certain embodiments including the capability of settling a living trust upon the death of one or more settlors and related irrevocable trusts, such as for example a “B” trust in an “AB living trust”;

automated generation of documents for settlement of a trust, in certain embodiments including notices to creditors, credit bureaus, beneficiaries, and insurance companies as well as tax or other government reporting documents;

automated allocation of income among trusts or separate accounts within a trust;

automated accounting for changes in trust asset value or receipts or disbursement of assets;

automated providing of administration suggestions to the trust administrator;

automated storage of trust related information in an associated database as a user moves from one program section or screen to another;

automated associated database corruption correction;

single entry of data and automated population of the data as needed in disparate forms or reports;

automated asset ledger printout for execution by an appropriate entity, such as the trustee; and

automated adjustment of data and asset entry and management according to the laws of the applicable State (or other locale if desired).

In certain embodiments, the disclosed system includes an asset distribution process that can be triggered upon the death of the grantor. This process can include identifying the grantor, beneficiaries, and assets to be transferred to the beneficiaries. The process can conclude when the assets listed in the trust's ledger have all been distributed and, if desired, the ledger has been verified. From this point, if any of the beneficiary trusts are managed by the present system, the assets received from the grantor's trust can be added to the beneficiary trust and the process can start again but with the beneficiary becoming the grantor in effect.

Some embodiments of the presently disclosed system can be configured to manage the interaction of two or more separate trust accounts. These embodiments can allow and track the transfer of income from and between trusts, and thereafter each trust's ledger is preferably updated and verified. If a grantor dies, thereby triggering a distribution of assets, and at least one of the beneficiaries is a trust managed by the presently disclosed system, the grantor's assets can be transferred to the beneficiary's trust. The ledgers of both trusts can be updated and verified.

In certain embodiments, the system can automatically print letters and notices to third parties to inform them of the grantor's death and, if desired, to further inform them that any business with the creditor should be closed.

In certain embodiments, the system can maintain a library of applicable laws for each jurisdiction in which the trust might be administered. In certain embodiments, the library may be maintained by a editable and expandable database.

In certain embodiments, the system can automatically store data that has been entered but without any special action being taken by the user. For example, certain actions can trigger the automatic storage function of the present application such as movement between program sections and screens.

In certain embodiments, system copy protection can be provided. Certain embodiments can include an automated associated database corruption correction feature.

In another aspect, the features noted above may variously be utilized to perform the method of operation they facilitate. In addition, such methods may variously be utilized to generate revenue from, or otherwise operate a business that provides or supports, sales, establishment, or administration of trusts.

There are other alternative or additional features or aspects of the present invention. They will become apparent as this specification proceeds.

In this regard, this Brief Summary of Aspects of the Invention is not to be construed as itself limiting of the invention or various aspects of the invention or its preferred embodiments, or as requiring that a given embodiment of the invention must include any particular features or advantages recited herein or address all issues noted in the Background section.

### BRIEF DESCRIPTION OF THE DRAWINGS

The preferred embodiment of the present invention is disclosed in conjunction with the accompanying drawings, in which:

FIG. 1 is a screen shot of a screen display (“screen shot”) of the preferred system;

FIG. 2 is a screen shot of the preferred system;

FIG. 3 is a background screen of the preferred system;

FIG. 4 is a splash screen shot of the preferred system;

FIG. 5 is a splash screen shot of the preferred system;

FIG. 6 is a screen shot of the preferred system;

FIG. 7 is a screen shot of the preferred system;

FIG. 8 is an overlay window screen shot of the preferred system;

FIG. 9 is a screen shot of the preferred system;

FIG. 10 is a screen shot of the preferred system;

FIG. 11 is a screen shot of the preferred system;

FIG. 12 is a screen shot of the preferred system;

FIG. 13 is an overlay window screen shot of the preferred system;

FIG. 14 is a pop-up window screen shot of the preferred system;

FIG. 15 is an overlay window screen shot of the preferred system;

FIG. 16 is an Application for Employer Identification Number generated and displayed by the system;

FIG. 17 is an overlay window screen shot of the preferred system;

FIG. 18 is a form automatically generated by the preferred system;

FIG. 19 an overlay window screen shot of the preferred system;

FIG. 20 is a letter automatically generated by the preferred system;

FIG. 21 is an overlay window screen shot of the preferred system;

FIG. 22 is an overlay window screen shot of the preferred system;

FIG. 23 is an overlay window screen shot of the preferred system;

FIG. 24 is an overlay window screen shot of the preferred system;

FIG. 25 is a letter automatically generated by the preferred system;

FIG. 26 is an overlay window screen shot of the preferred system;

FIG. 27 is a letter automatically generated by the preferred system;

FIG. 28 is a letter automatically generated by the preferred system;

FIG. 29 is a letter automatically generated by the preferred system;

FIG. 30 is notice automatically generated by the preferred system;

FIG. 31 is an overlay window screen shot of the preferred system;

FIG. 32 is a letter automatically generated by the preferred system;

FIG. 33 is a screen shot of the preferred system;

FIG. 34 is an asset list automatically generated by the preferred system;

FIG. 35 is a screen shot of the preferred system;

FIG. 36 is an asset allocation listing automatically generated by the preferred system;

FIG. 37 is an asset allocation form automatically generated by the preferred system;

FIG. 38 is an asset allocation form automatically generated by the preferred system;

FIG. 39 is an asset allocation form automatically generated by the preferred system;

FIG. 40 is an overlay window screen shot of the preferred system;

FIG. 41 is a tax return form automatically generated by the preferred system;

FIG. 42 is a tax return form automatically generated by the preferred system;

FIG. 43 is a tax return form automatically generated by the preferred system;

FIG. 44 is a tax return form automatically generated by the preferred system;

FIG. 45 is a tax return form automatically generated by the preferred system;

FIG. 46 is an overlay window screen shot of the preferred system;

FIG. 47 is an overlay window screen shot of the preferred system;

FIG. 48 is a letter automatically generated by the preferred system;

FIG. 49 is a report automatically generated by the preferred system;

FIG. 50 is a screen shot of the preferred system;

FIG. 51 is an overlay window screen shot of the preferred system;

FIG. 52 is an overlay window screen shot of the preferred system;

FIG. 53 is an overlay window screen shot of the preferred system;

FIG. 54 is an overlay window screen shot of the preferred system;

FIG. 55 is an overlay window screen shot of the preferred system;

FIG. 56 is an overlay window screen shot of the preferred system;

FIG. 57 is an overlay window screen shot of the preferred system;

FIG. 58 is an overlay window screen shot of the preferred system;

FIG. 59 is an overlay window screen shot of the preferred system;

FIG. 60 is an overlay window screen shot of the preferred system;

FIG. 61 is a flow chart showing a method of use of the preferred system of FIGS. 1-60 (the “system”) to set up a trust;

FIG. 62 is a flow chart showing a method of use the system to administer a trust in compliance with applicable laws;

FIG. 63 is a flow chart showing a method of use of the system to file taxes for a trust;

FIG. 64 is a flow chart showing a method of auto-saving implemented by the system;

FIG. 65 is a flow chart showing a method of allocating income to one or more trusts with the system;

FIG. 66 is a flow chart showing a method of use of the system to identify a an asset transfer event and proceed accordingly;

FIG. 67 is a flow chart showing a method of use of the system to update and verify changes to trust assets including by, if desired, applying an electronic signature to a ledger;

FIG. 68 is a flow chart showing a method of use of the system to administer an AB living trust;

FIG. 69 is a flow chart showing a method of use of the system to provide third party notices; and

FIG. 70 is a flow chart showing a method of use of the system to provide asset distribution to successor trusts.

It is to be understood that all data shown in the drawings is strictly exemplary, for purposes of demonstration of how data is entered and can flow through the various screens and the system logic.

### DETAILED DESCRIPTION OF THE PREFFERED EMBODIMENTS

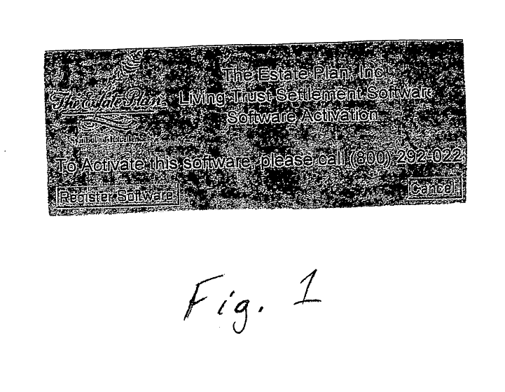

With reference to FIG. 1, this screen shot is the first screen that appears when the user runs the preferred trust administration system software for the first time. When the user presses the “Register Software” button on this screen, the user is presented with a screen in which to enter user codes, provided to the user when the user calls the telephone number also shown on this screen. Most commonly, the user activates the software to commence administration of an estate upon the death of a grantor or other commencement of need for administration of a trust.

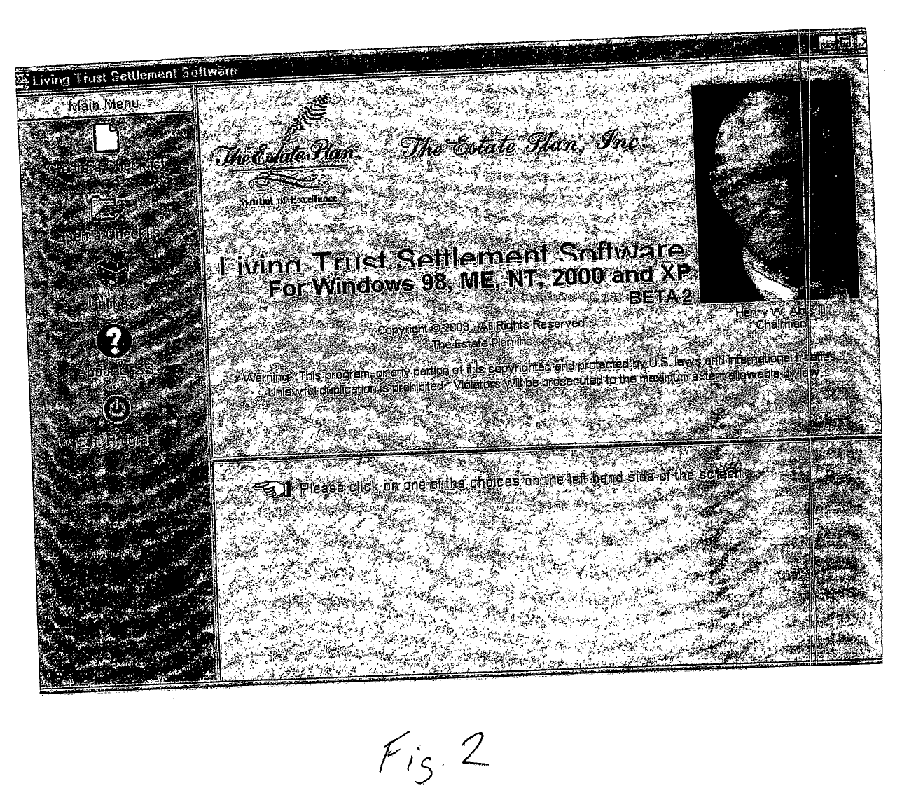

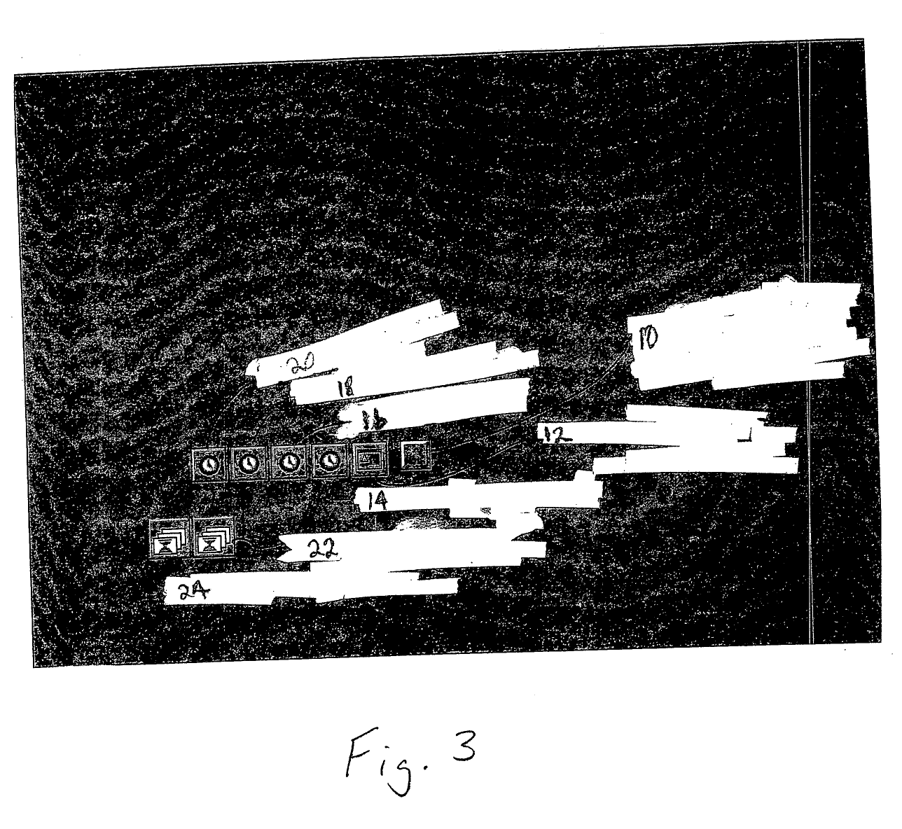

With reference to FIG. 2, this screen appears when the use enters proper user codes. The program's main screen, shown in FIG. 3, runs in the background of this and all further screens for the trust administration program. Box 10 provides Active X control for the copy protection scheme, including the call-in procedure explained above with regard to FIG. 1. Box 12 provides message display. Clock 14 removes all groups on the screen to allow new groups to commence operation on the screen. Clock 16 activates groups. Clock 18 ensures checklists are completed and saves entered data. Clock 20 removes groups when not needed or no longer open as the user moves from screen to screen in the trust administration programs. Box 22 provides activation of large image files for appearance on screen, and Box 24 provides activation of small image files for appearance on screen.

FIG. 4 shows a splash screen that overlays the screen of FIG. 3 as part of the screen shown in FIG. 2.

FIG. 5 provides another splash screen overlayed as part of the screen of FIG. 2.

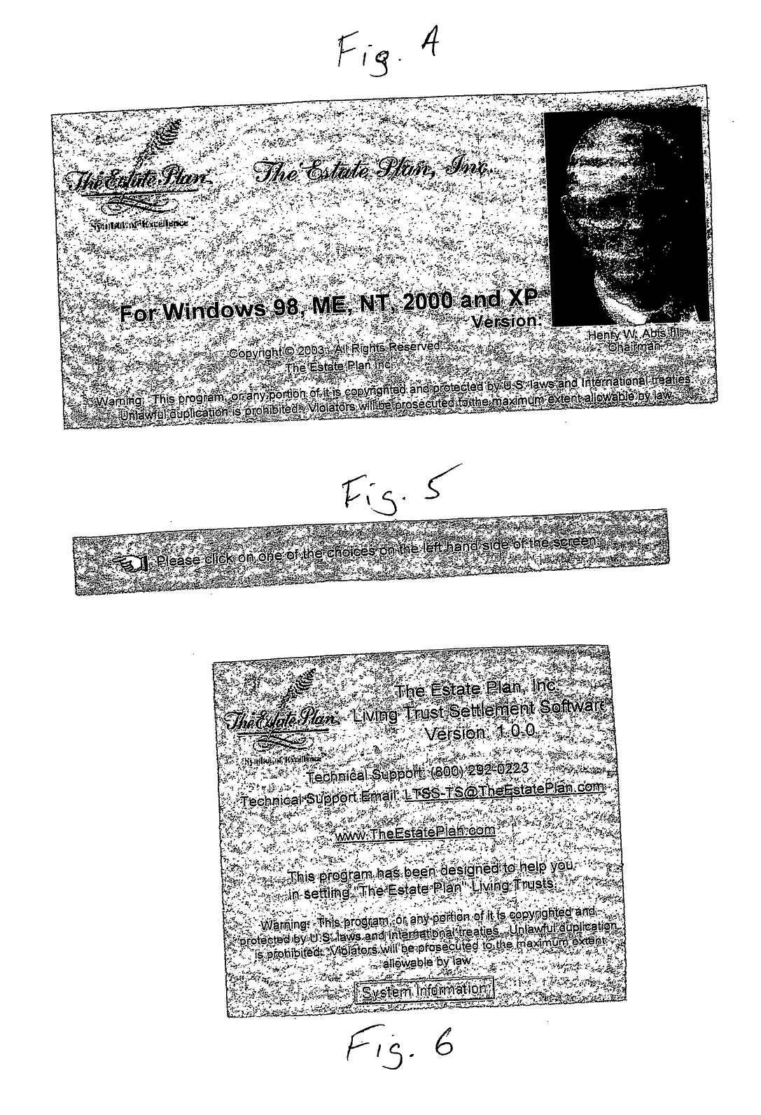

FIG. 6 shows the screen that appears when the user clicks on the “About LTSS” button on the screen of FIG. 2.

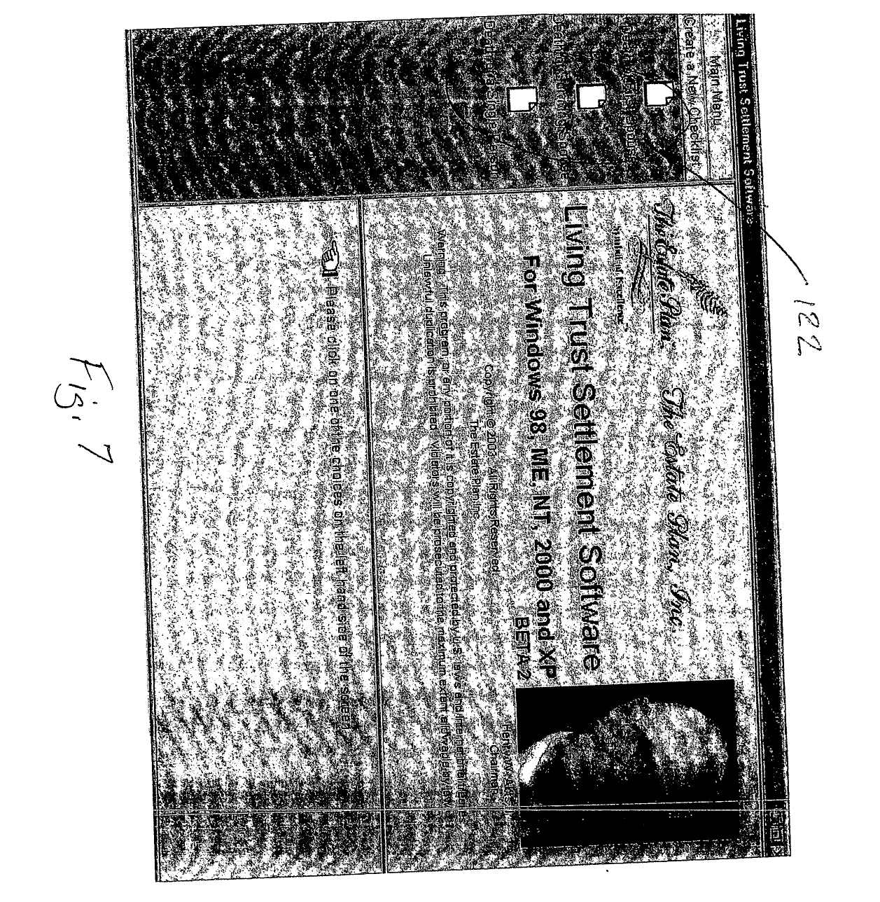

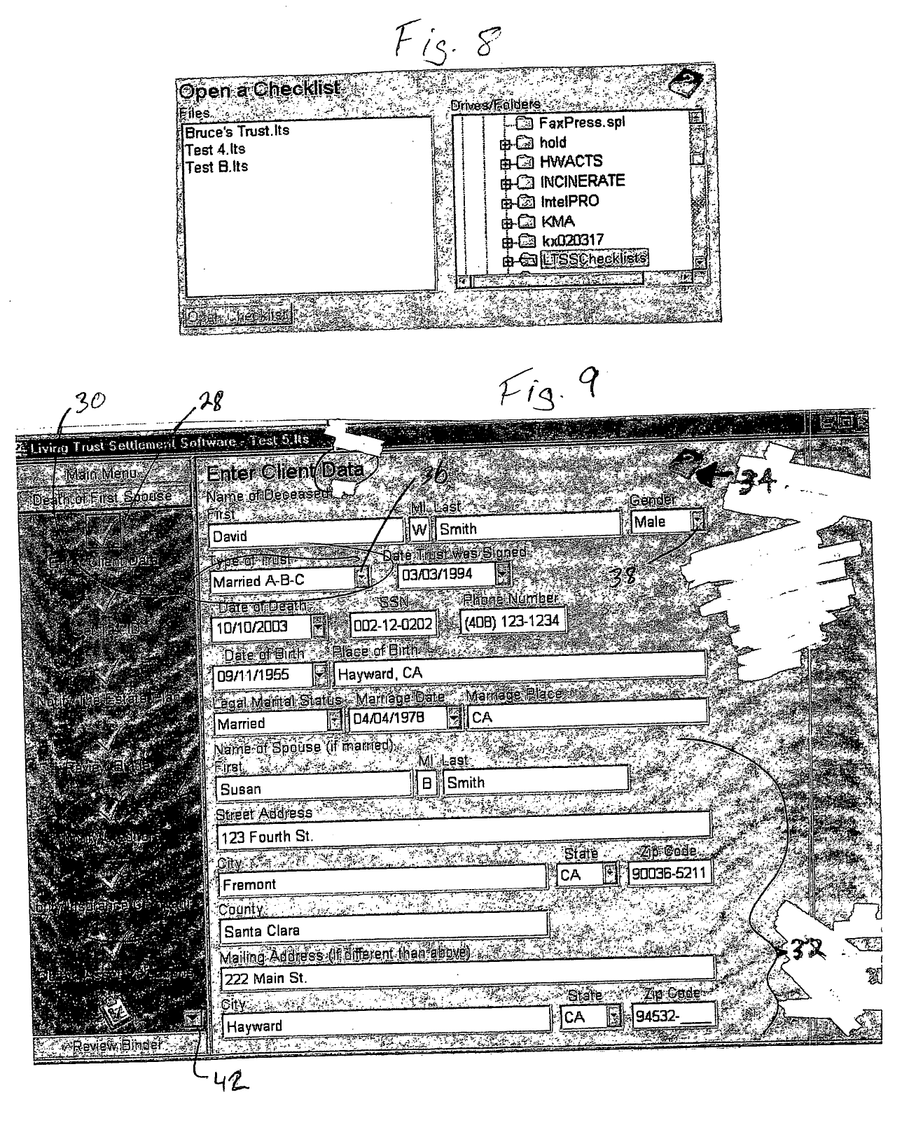

FIG. 7 shows the screen that appears when the user clicks on the “Create a New Checklist” button on the screen of FIG. 2.

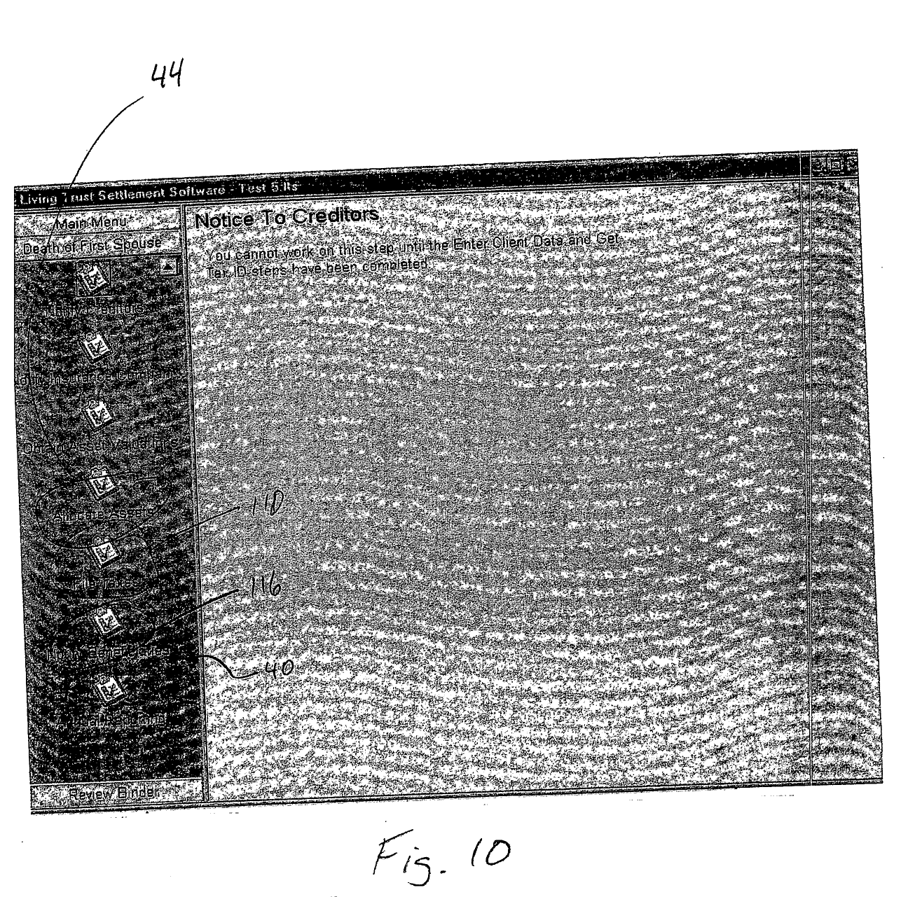

FIG. 8 shows a window that appears when the user clicks on the “Open a Checklist” button on the screen of FIG. 2. This screen provides a list of trusts, generally 26, established by, and accessible through, the folder selected by the user on the drives/folders section of this window. The user may then click on a given trust file, such as that listed, as an example, as “Bruce's Trust.lts.” This action causes an associated program, Microsoft Explorer, to open that .lts file with the MS Explorer program and interface.

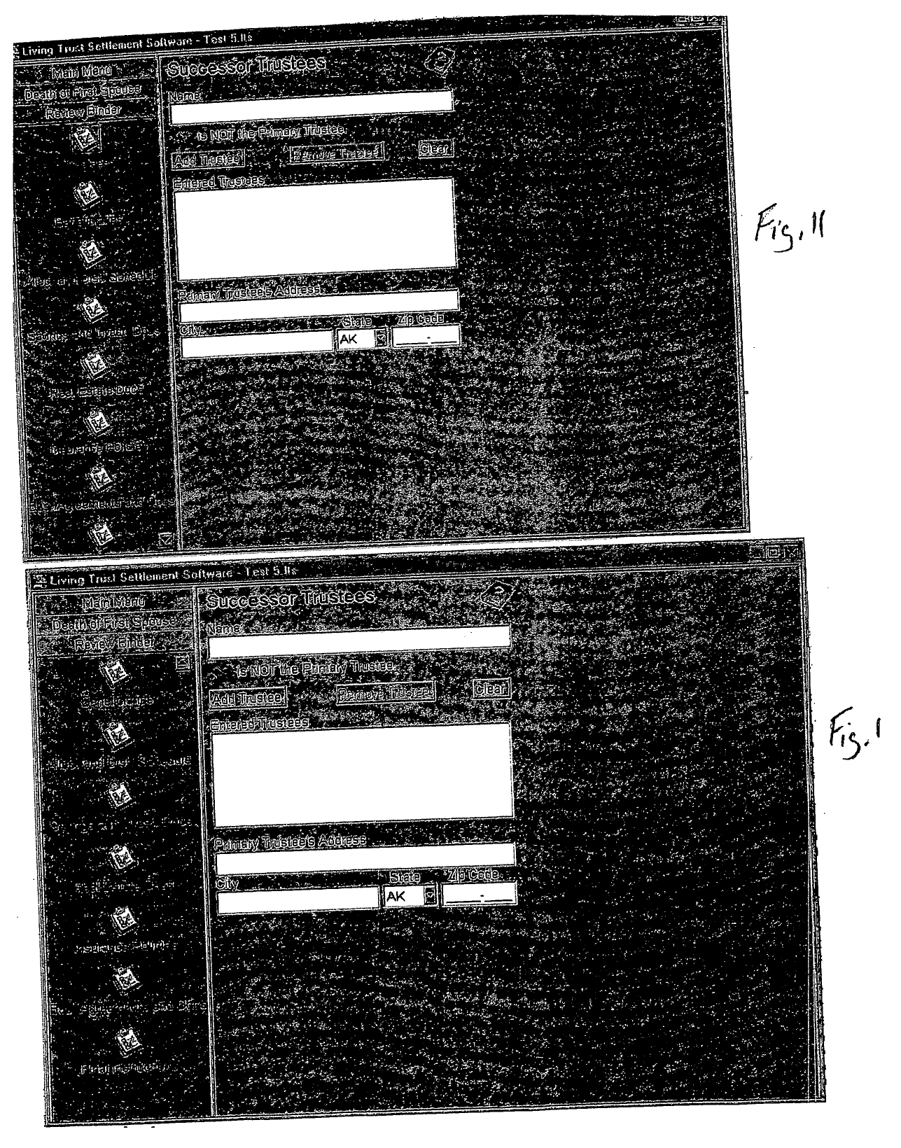

FIG. 9 shows the first screen, with sample data, that appears if the user were to click on the “Bruce's Trust.lts” file name in FIG. 8. (The same type of screen, without data, appears if the user clicks on the “Death of First Spouse” button on the screen of FIG. 7, for entry of data to commence administration of a trust.) If the user exits this screen, the trust administration program provides a pop-up window advising of missing data if data has not been entered in all required fields. This screen also prevents the user from accessing certain sections of the trust administration program until prior required sections have been completed. For example, the user must first proceed through the “Obtain Asset Valuations” step shown in the checklist on this screen before the user may proceed to “Asset Allocation” steps described infra.

This screen, of FIG. 9, also includes trust identification data 30, which, if edited in a fashion that would require re-allocation of assets among trusts according to applicable legal rules, causes a screen to pop-up to advise of the need to revise asset allocations in succeeding sections of the program, described infra as noted above. Note that this screen also provides a box highlight, e.g., 28, shown on the checklist bar, indicating which screen, accessible through this bar, is currently open. Further, the lower section 32 of this screen, providing a place for entry of data for a spouse, does not appear if data has been entered showing that this section is not applicable for this particular trust.

In the screen of FIG. 9, certain data entry fields, e.g., 36, 38, have arrows on which the user clicks to obtain access to drop down data selection sections, from which the user may select the appropriate data for entry into the field. Finally, this screen, like most others, provides context sensitive help accessible through a help button 34.

FIG. 10 shows the screen that appears if the user clicks on the Notify Creditors button on the screen of FIG. 9 prior to completing the identified steps. Note that this view of this particular screen also shows the lower section of the menu bar, generally 40, which is also accessible by clicking on the downward arrow 42 shown on the screen display of FIG. 9. This particular screen shot also includes the “Allocate Assets” 44 which does not appear on the version of the screen that would not appear on administration of a trust for a deceased single person or surviving spouse.

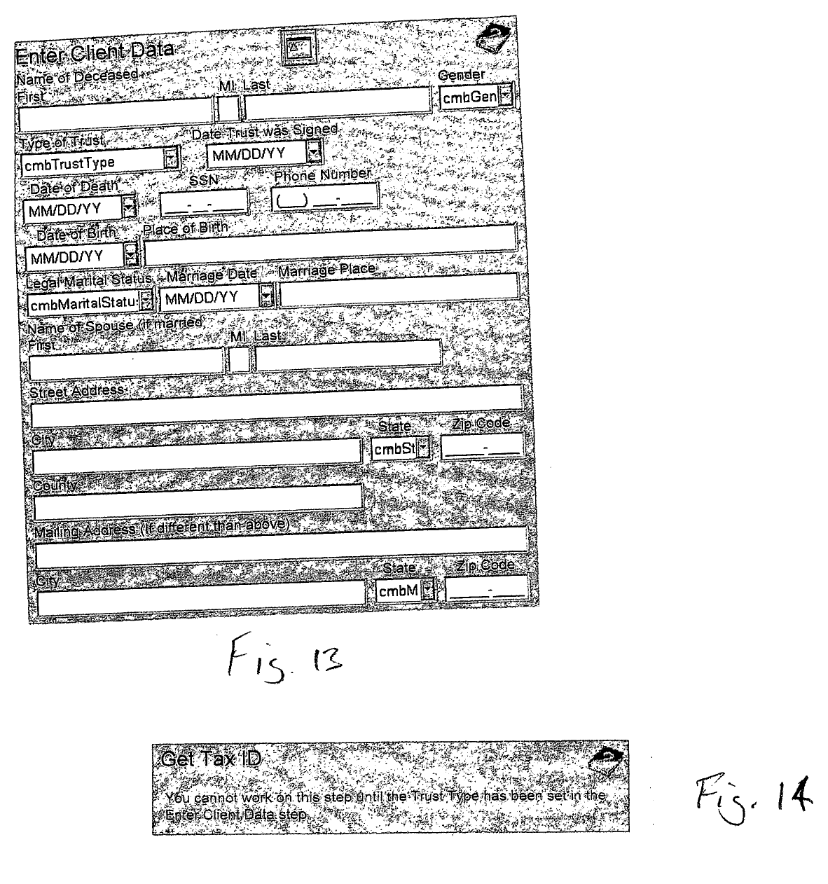

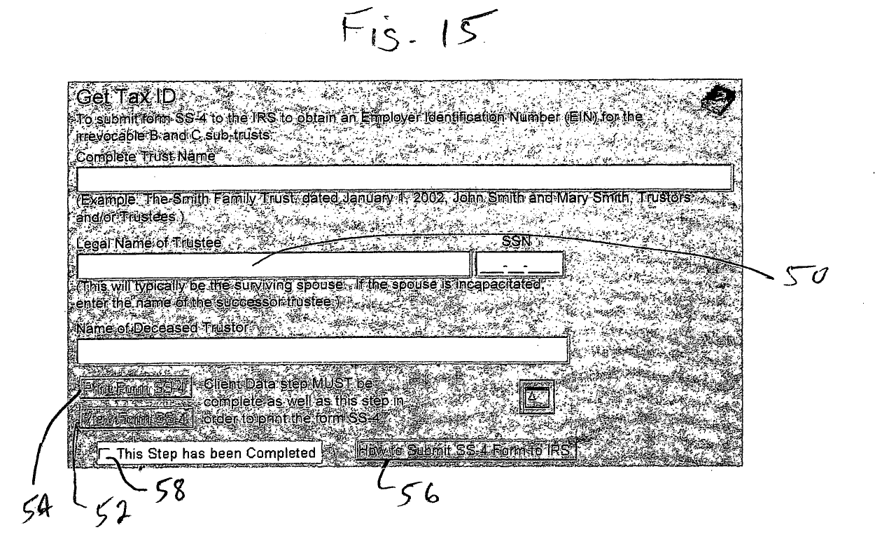

FIG. 11 shows the screen that appears if the user clicks on the Review Binder buttons of previous screens, e.g., as shown in FIG. 10. The size of this screen is adjustable, with the minimum screen size set to the default of 800×600 pixels. The user may, if needed due to the selected screen size, scroll downward through the left menu bar arrow 46 to procure the options provided on the lower section 48 of the screen as shown in FIG. 12. The “Binder” refers to a physical binder or other storage medium for the documents (or scanned or otherwise recorded documents) of the type identified in FIGS. 11 and 12.

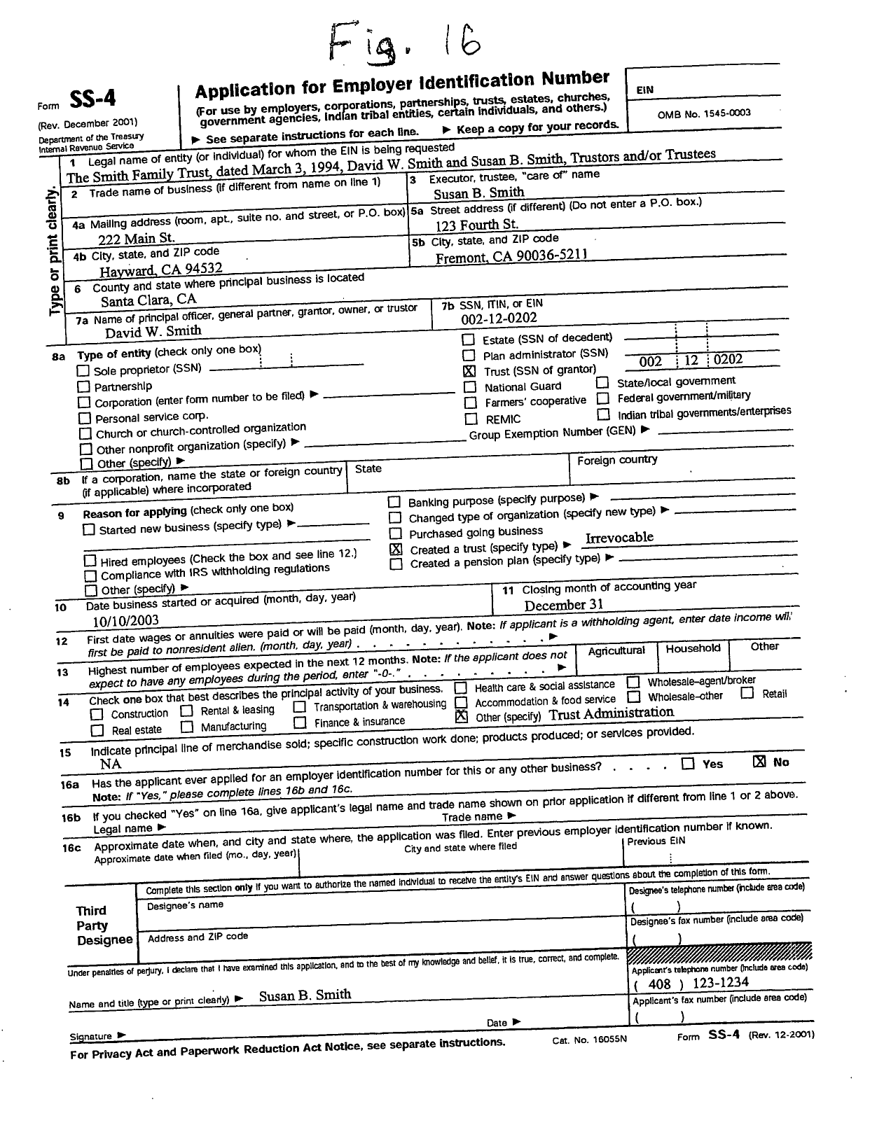

FIG. 13 shows the “Enter Client Data” overlay section of the screen appearing on FIG. 9 when the user first accesses the screen of FIG. 9 to enter data.

FIG. 14 shows the pop-up window that appears on the user's display if the data required by the Enter Client Data screen of FIG. 13 has not yet been entered and the user tries to move on in the program.

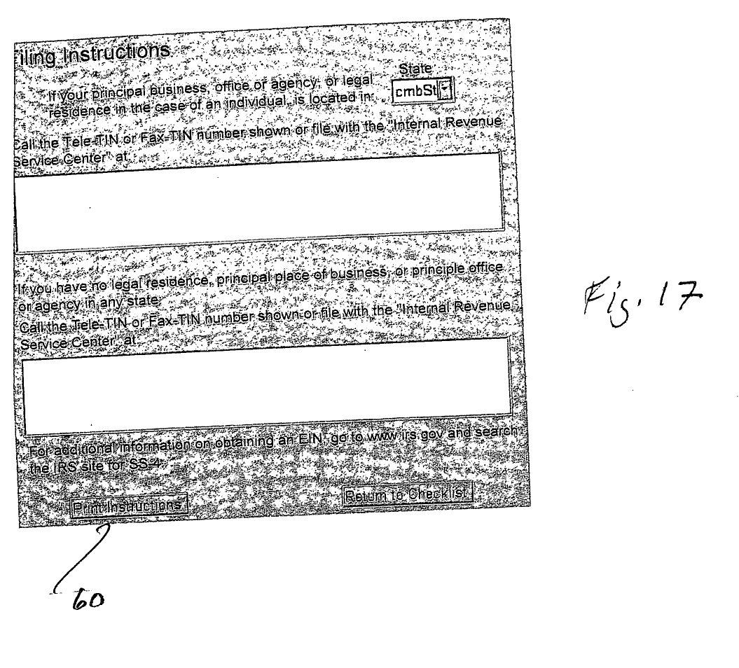

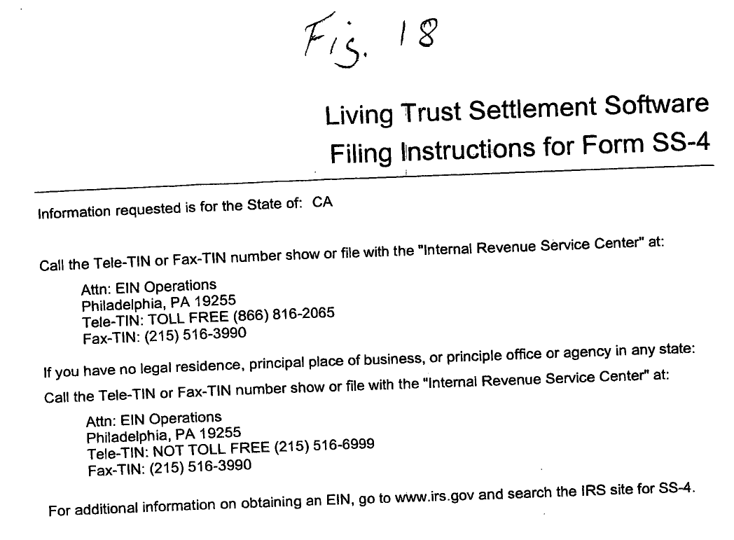

FIG. 15 shows the overlay window that appears when the user clicks on the “Get Tax ID” button of FIG. 9. The trust administration program automatically fills the “Legal Name of Trustee” field 50 with the name of the surviving spouse entered in the prior screen shown in FIG. 13. If the user clicks on the “View Form SS-4” button 52, the program presents the user with a view of the official, government-approved Form SS-4 with pertinent data inserted into that Form automatically, as shown for example in FIG. 16. The user may click on the “Print Form SS-4” button 54 to print this Form. The user may also click on the “How to . . . ” button 56 to procure instructions for how file that form with the government. When the user has completed the Form, printed it, and filed it with the government, the user clicks on “This Step . . . . ” box 58, which results in a check appearing adjacent the “Get Tax ID” button on the screens in which it appears, such as FIG. 9 for example.

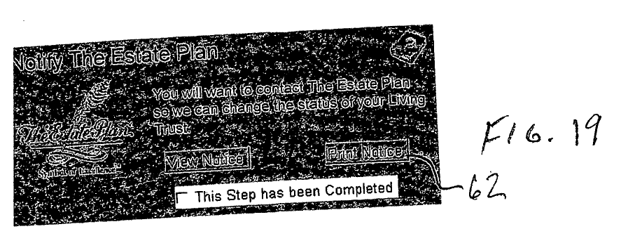

FIG. 17 is the screen that appears when the user clicks on the “How to submit . . . ” button 56 on the screen of FIG. 15. Depending on the state entered in the State field, the trust administration program enters the correct information for that location in the fields shown in blank in the screen of FIG. 17.

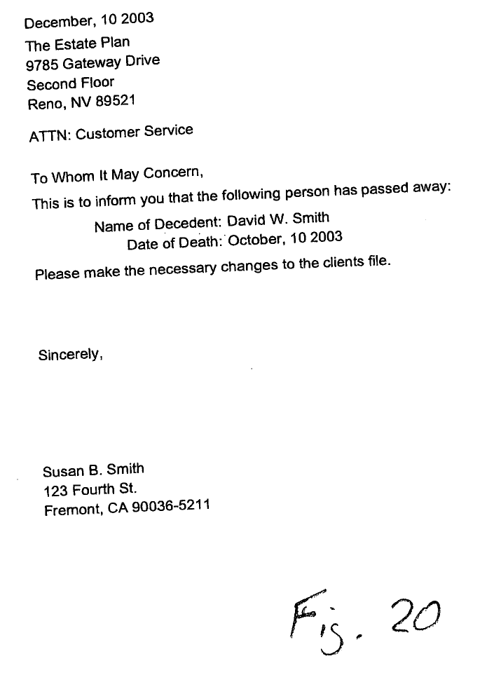

FIG. 18 is the screen that appears when the user clicks on the “Print Instructions” button 60 on the screen of FIG. 17.

FIG. 19 shows the screen that appears when the user clicks on the “Notify the Estate Plan” button on the screen of FIG. 9.

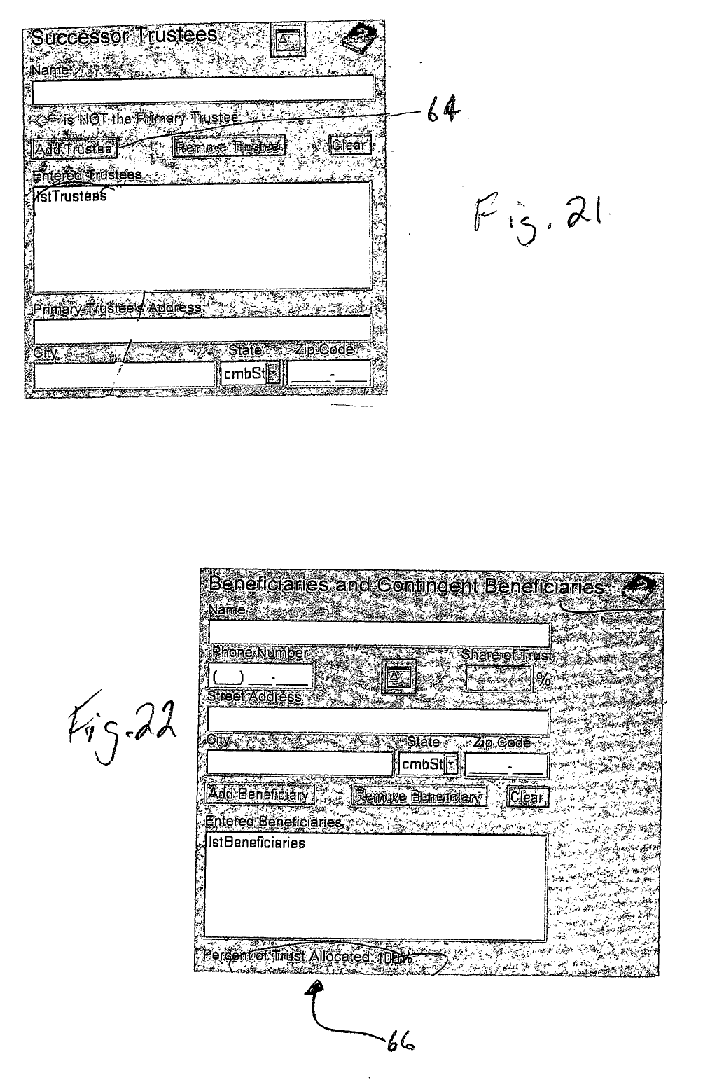

FIG. 20 shows the letter that the trust administration program automatically prints for the user when the user clicks on the “Print Notice” button 62 on the screen of FIG. 19.

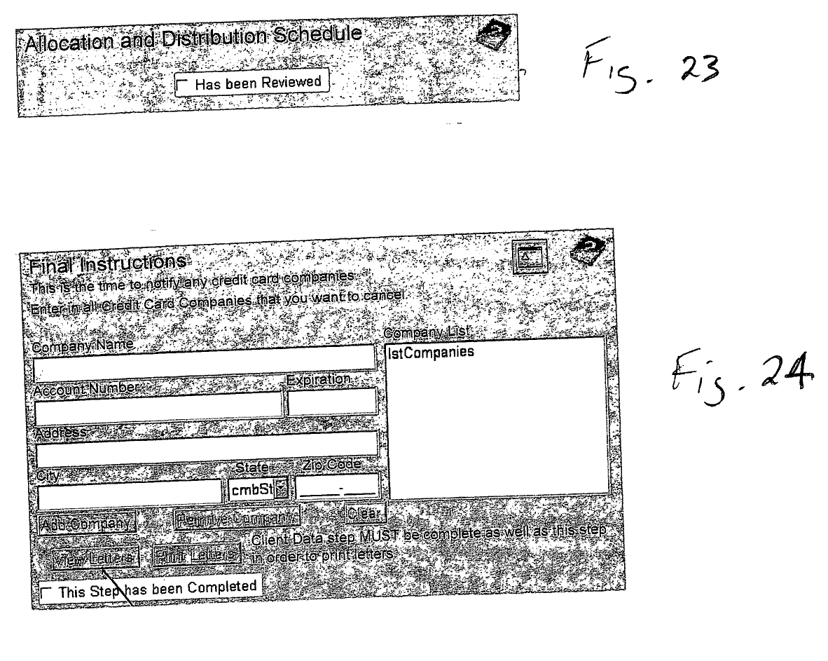

FIG. 21 shows the screen that appears when the user clicks on the “Trustees” button 64 on the screen of FIG. 11. Note that the “Add Trustee” button does not appear until the user enters a primary trustee.

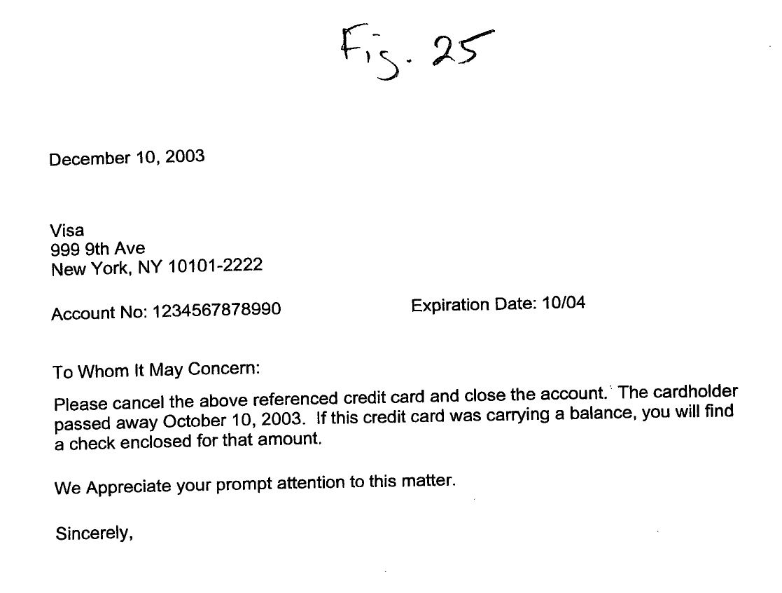

FIG. 22 shows the screen that appears when the user clicks on the “Beneficiaries” button on the screen of FIG. 11. This screen reports, in the Percent field 66, the percentage of assets allocated among the beneficiaries, and reports incorrect allocations exceeding 100%.

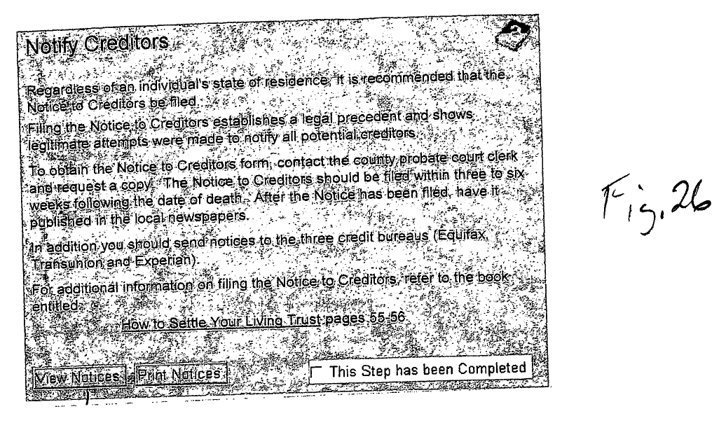

FIG. 23 shows the window that appears when the user clicks on the “Allocation and Dist. Schedule” button on the screen (window) of FIG. 11.

FIG. 24 shows the window that appears when the user clicks on the “Final Instructions” button on the screen of FIG. 12. When the user completes this screen by clicking in the “Completed” box and pressing “Enter” on the user's keyboard, this window closes and the screen shown in FIG. 9 appears.

FIG. 25 shows the type of letter that prints out automatically when the user clicks on the “Print Letters” button on the screen of FIG. 24.

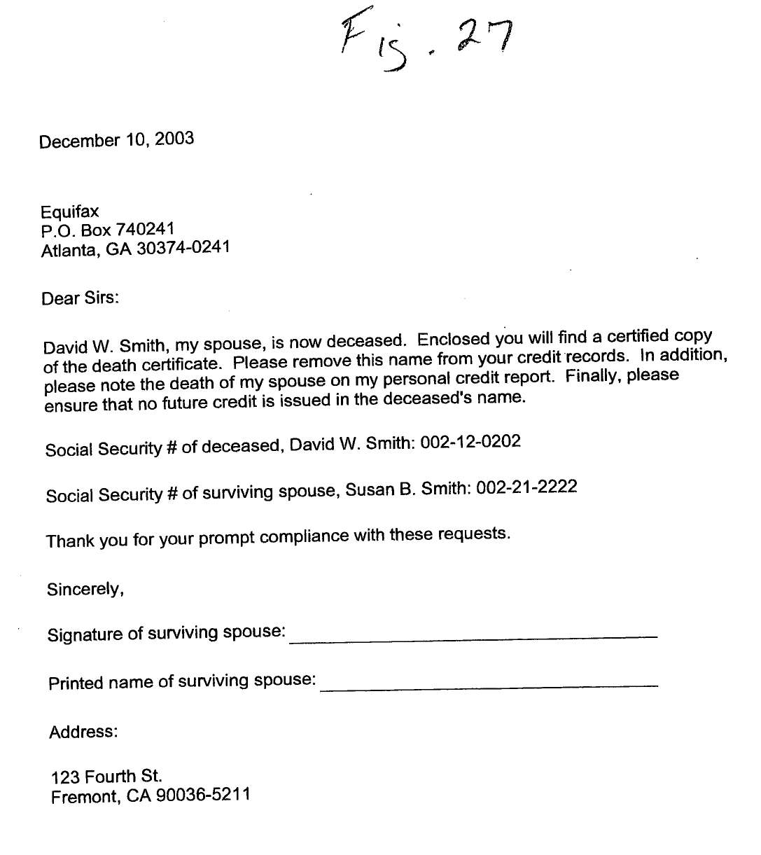

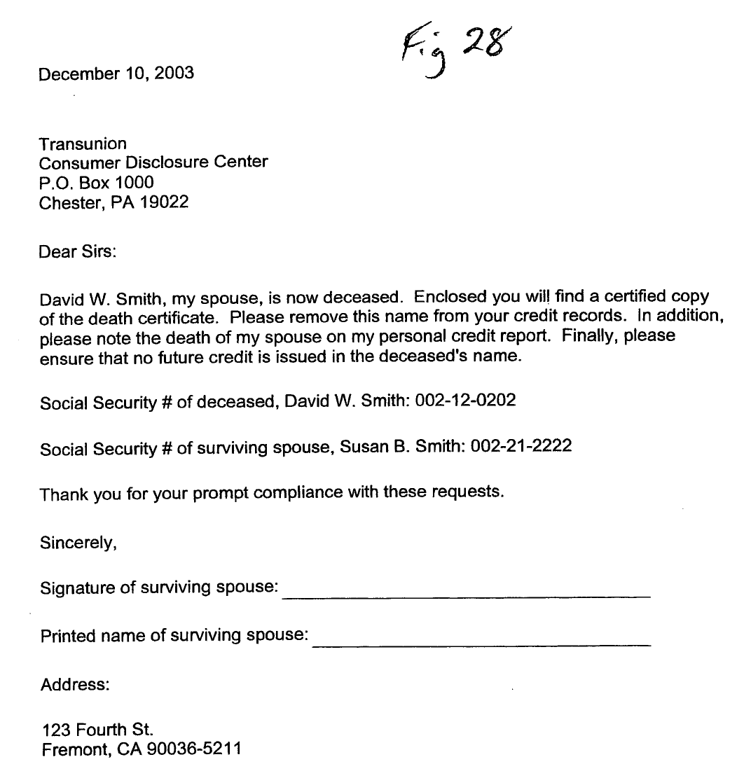

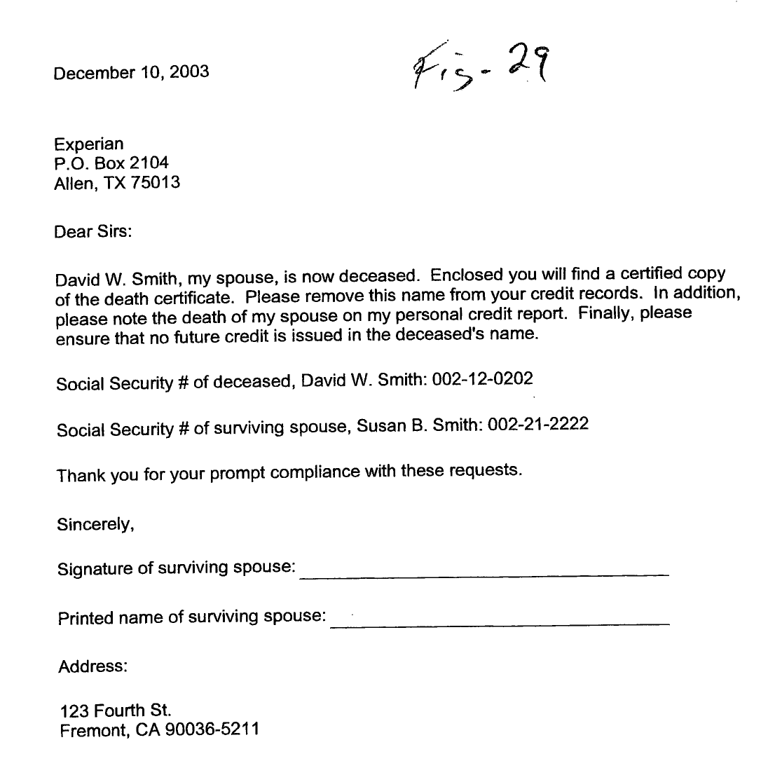

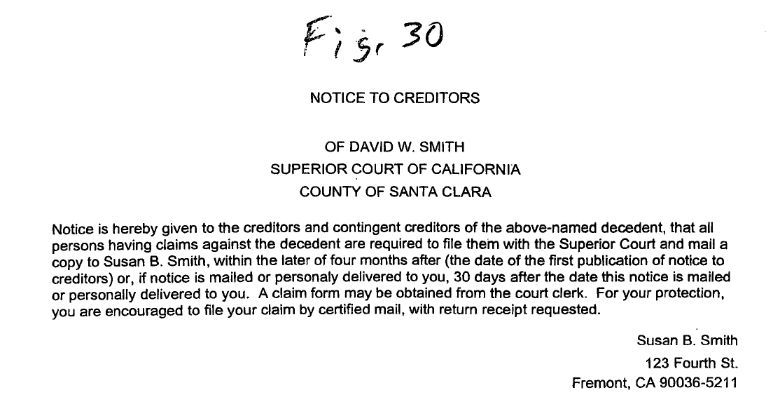

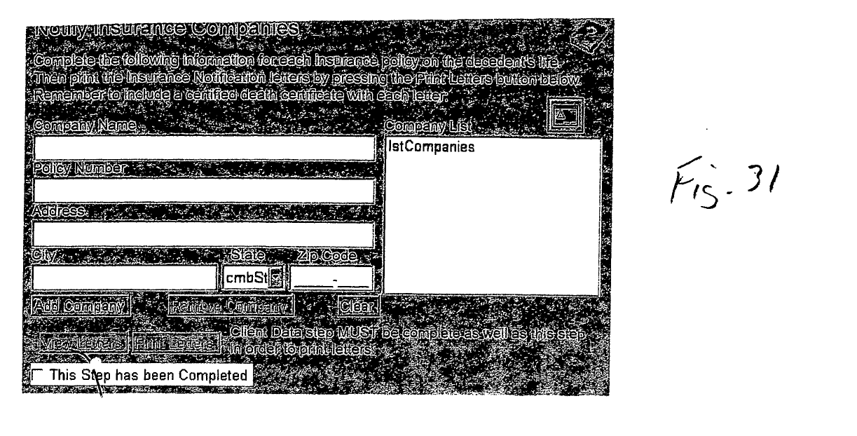

FIG. 26 shows the window that appears when the user clicks on the “Notify Creditors” button on the screen of FIG. 9. When the user clicks on the “View Notices” button 70 on this screen, the user is presented with two types of notices: (1) to credit bureaus as shown in FIGS. 27-29; and (2) for placement in a newspaper as shown in FIG. 30. The trust administration program automatically inserts correct information in, e.g., the notice of FIG. 30.

FIG. 31 shows the window that appears when the user clicks on the “Notify Insurance Companies” on the screen of FIG. 9.

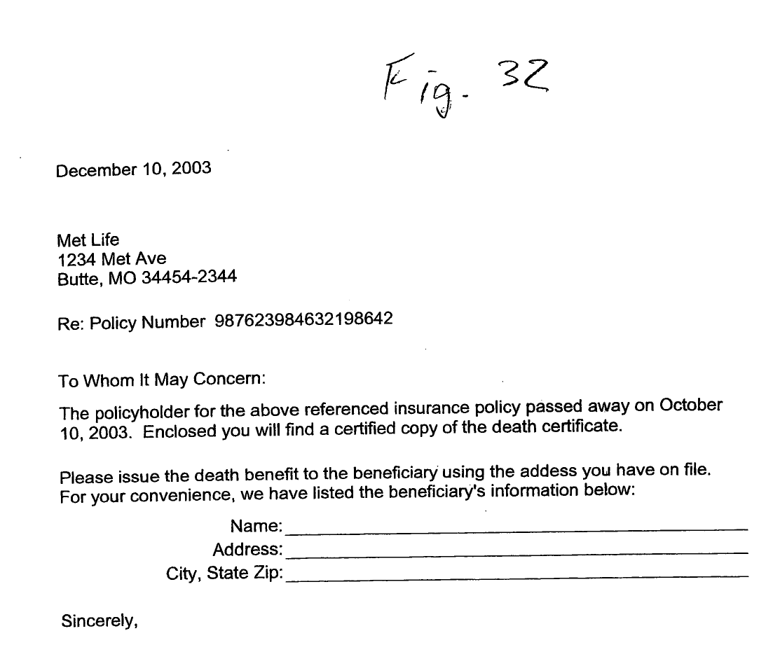

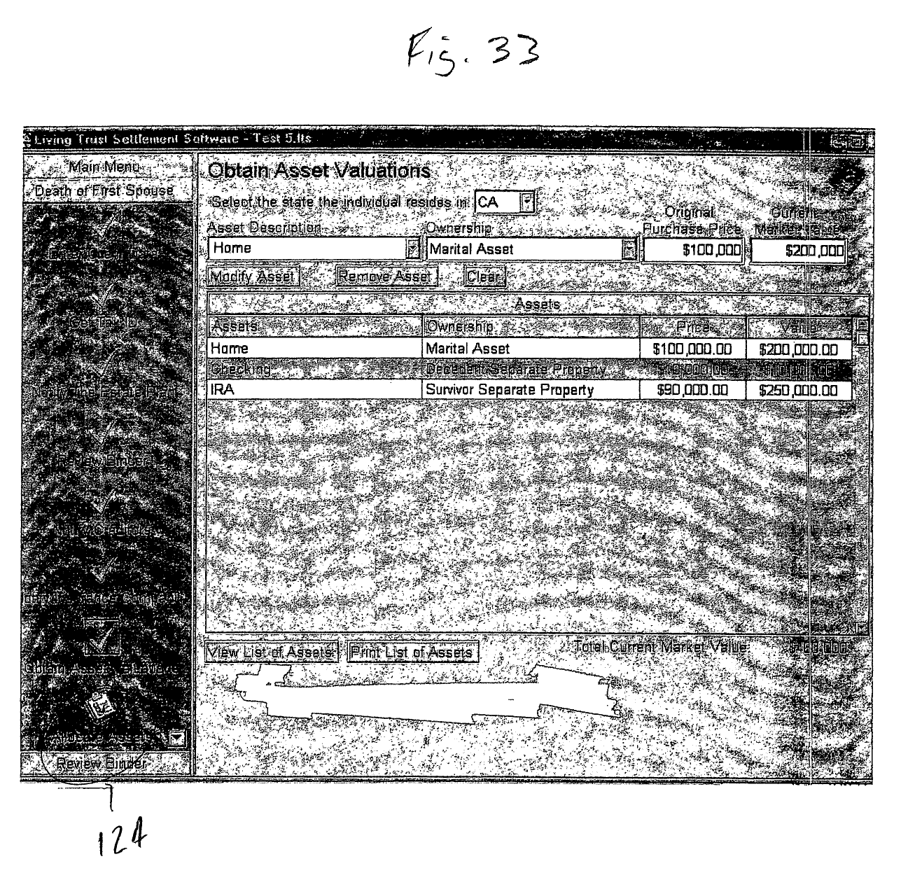

FIG. 32 shows the letter that automatically prints out when the user clicks on the “Print Letter” button 64 on the window of FIG. 31.

FIG. 33 shows the window that appears when the user clicks on the “Obtain Asset Valuations” button on the screen of FIG. 9. If the user revises the asset data previously entered in this section, the trust administration program automatically unchecks the “Allocate Assets” button shown on the screen of FIG. 10.

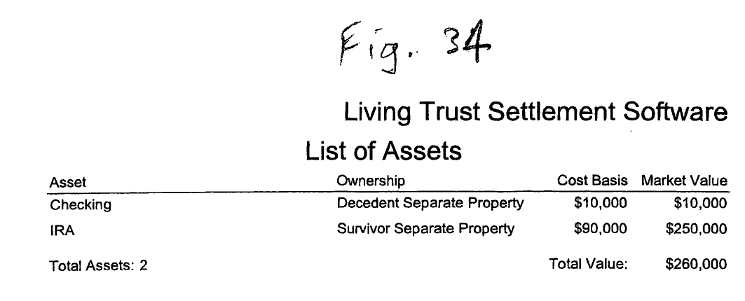

FIG. 34 shows an asset list display that appears if the user clicks on the “View List of Assets” button shown on the screen of FIG. 33.

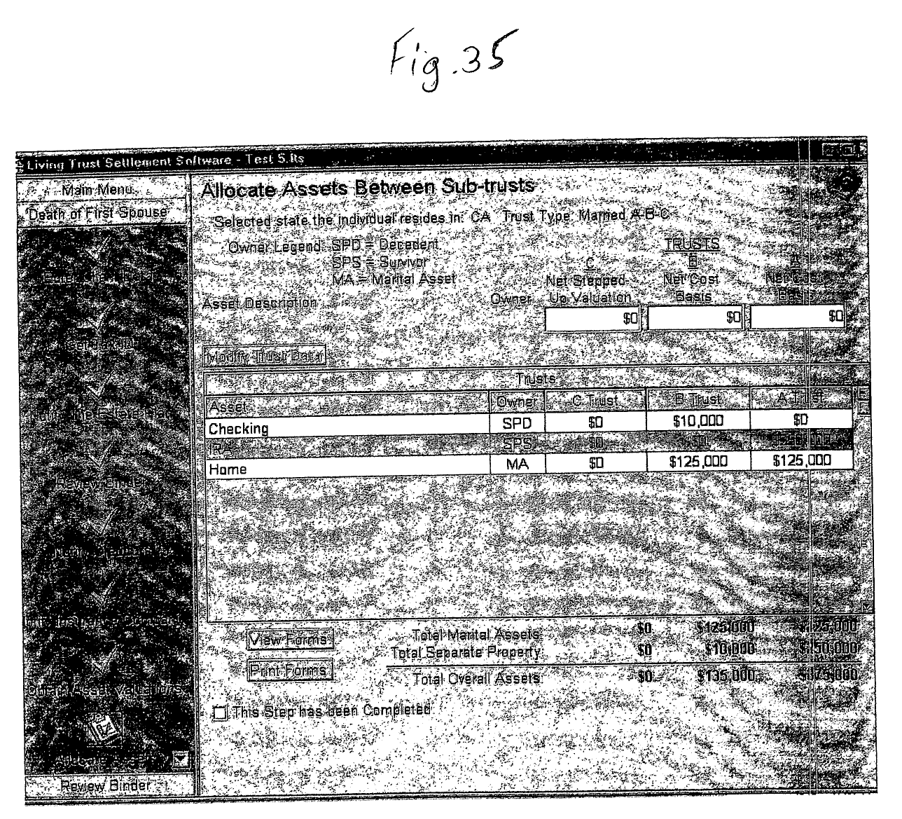

FIG. 35 shows the window that appears when the user clicks on the “Allocate Assets” button shown on the screen of FIG. 10. This trust administration program provides rules that prevent the user from editing trust valuations inconsistent with legal restrictions. The trust administration program also provides rules allowing allocations between trusts when proper but advising when the allocations are insufficient.

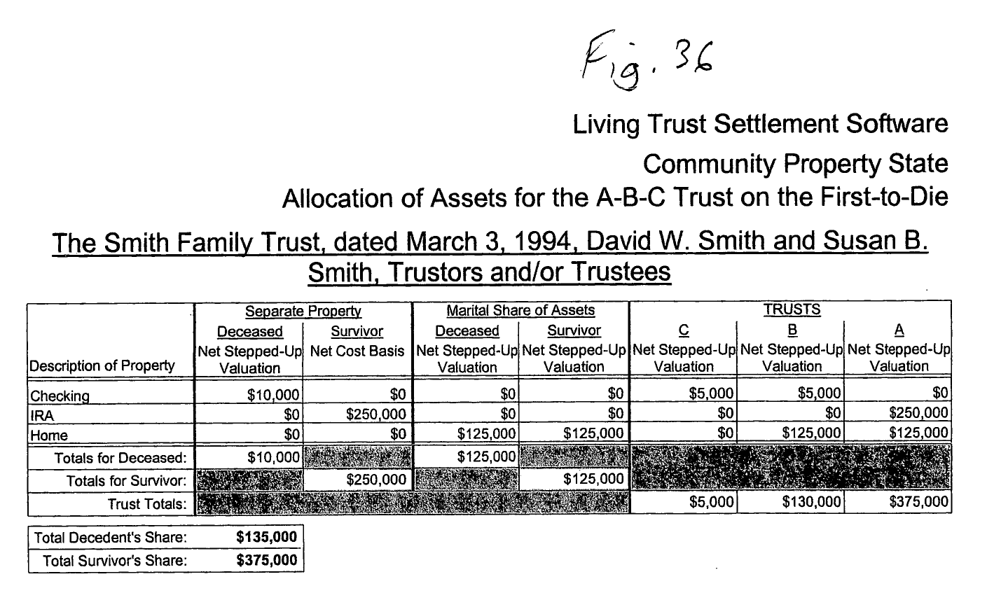

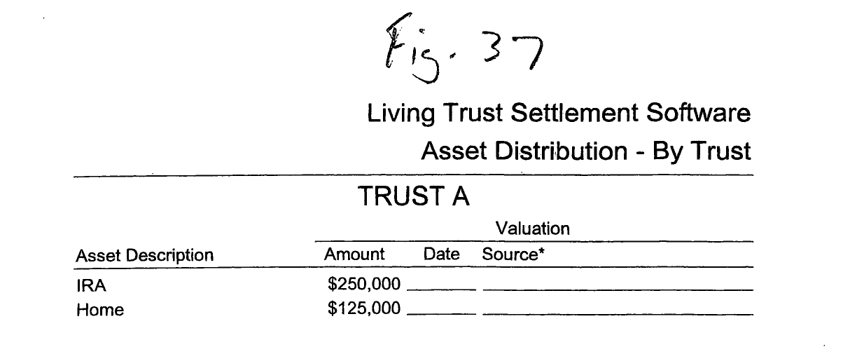

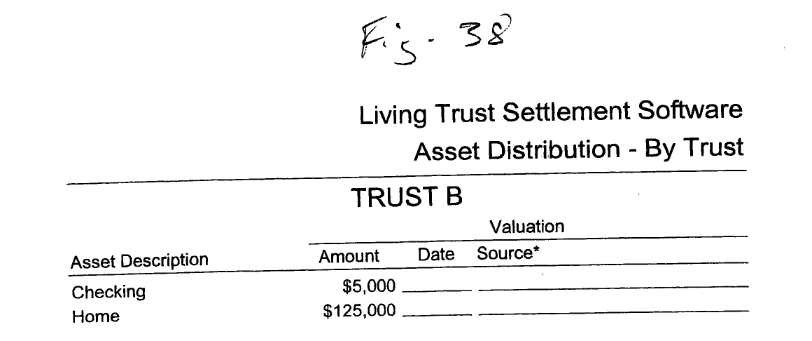

From the screen shown in FIG. 35, the user may view or print out asset allocation forms of the type shown in FIGS. 36-39. The ledgers shown in FIGS. 37-39 need merely be verified by the Trustee, preferably by printing, signing, and dating the ledgers, in order to accomplish allocation or re-allocation of the trust assets under the law. The Trustee or other user need perform no further tasks, such as the substantial effort and, often, expense of document recording or generation of further title transfer documentation, in order to accomplish the legal allocation as thus stated on such ledgers. The applicant contemplates that other verification methods may also be implemented, such as by automated computing execution techniques that are now commonly available and being further perfected to provide more reliable, effective, or ubiquitous methods of executing a record via automation.

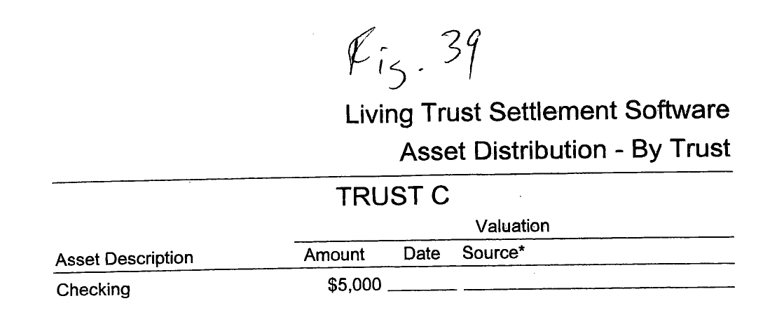

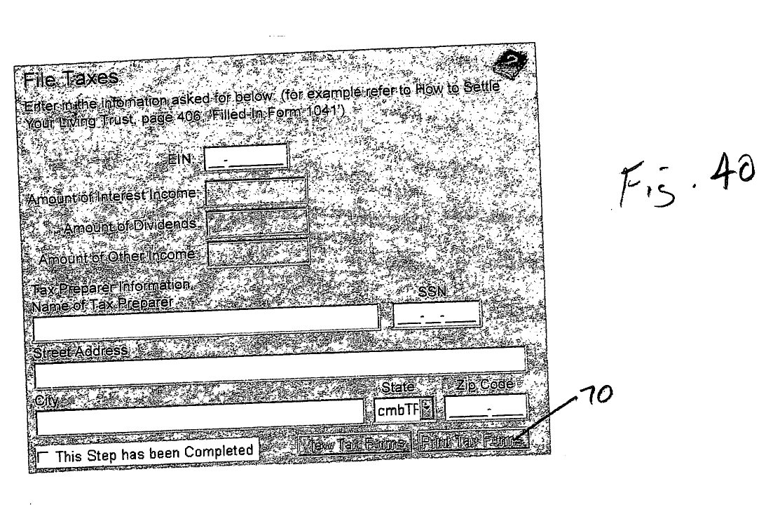

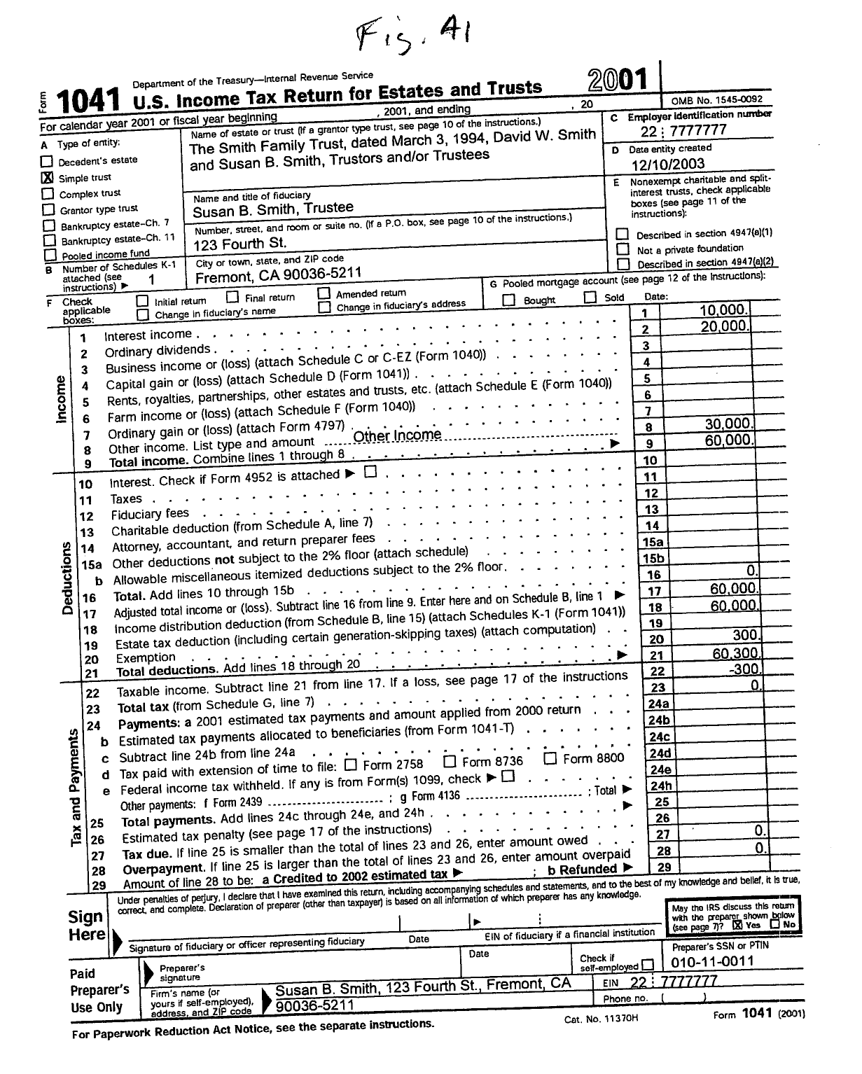

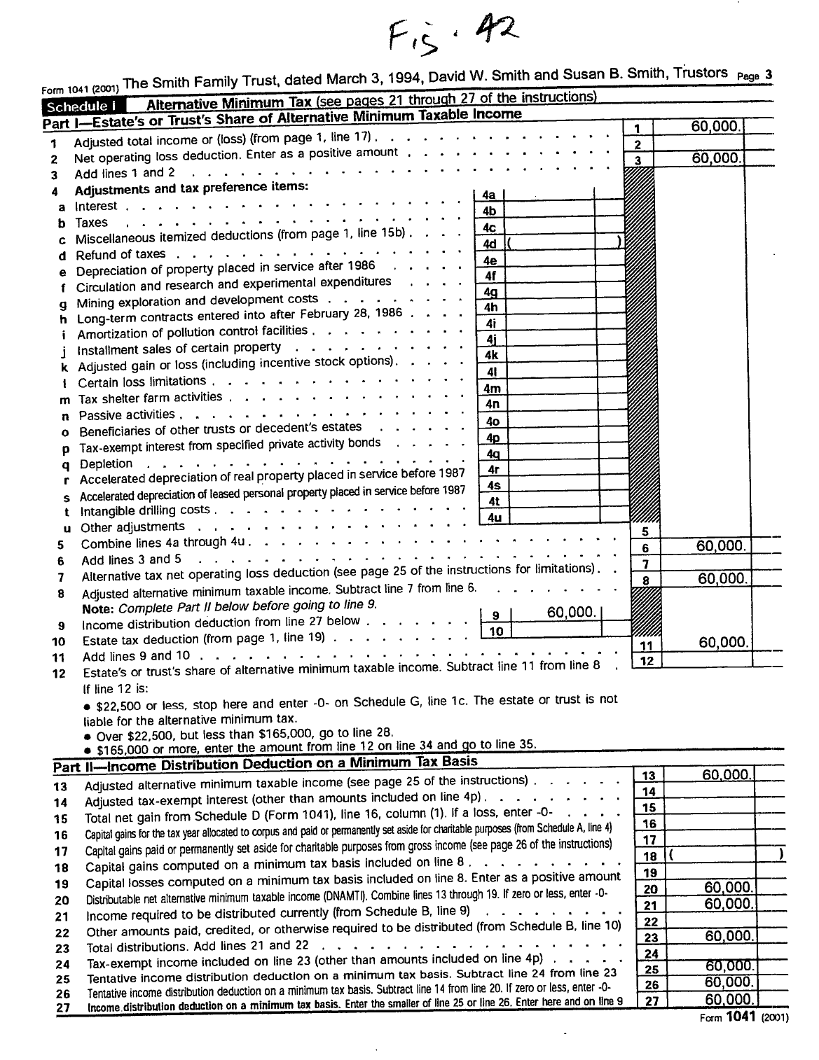

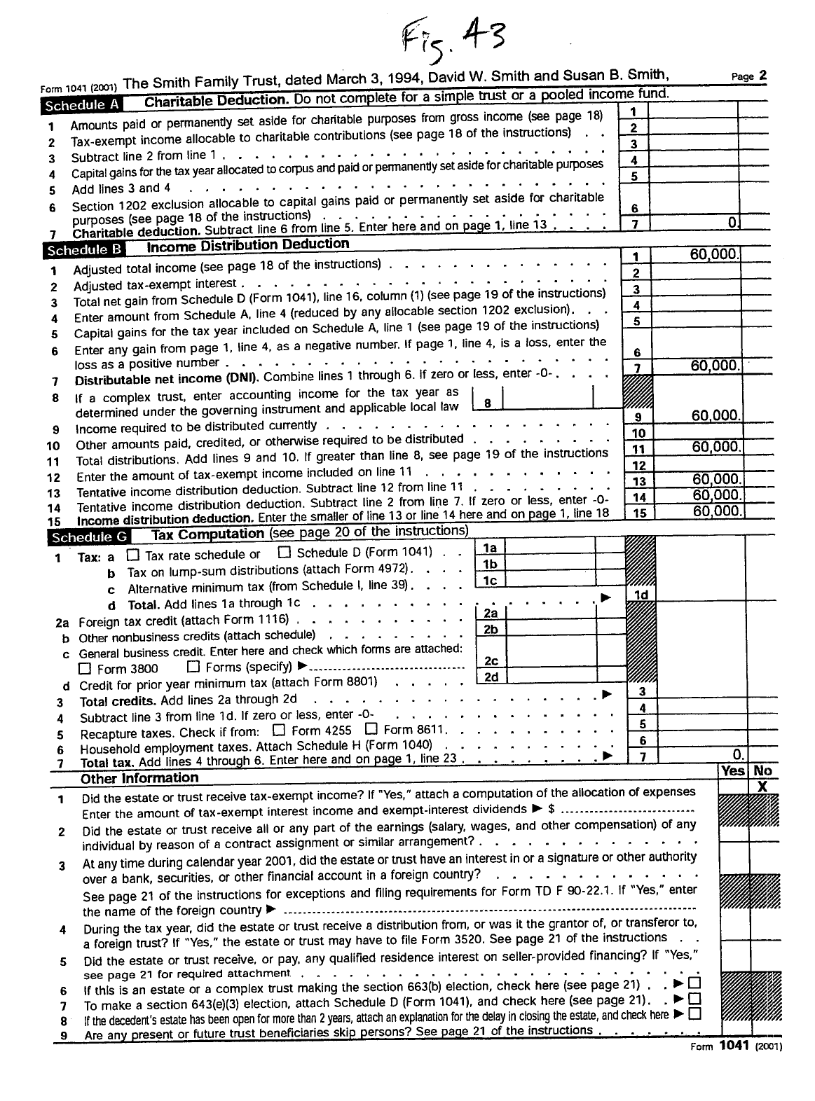

FIG. 40 shows the window that appears when the user clicks on the “File Taxes” button on the screen of FIG. 10. The program automatically provides the user with the official government-approved forms for tax filing when the user clicks on the “Print Forms” button 70. These forms are stored in PDF format on the CD or other storage media on which the trust administration program resides. Samples of the forms printed by the program, with automated entry of the data into the forms by the trust administration program, are shown in FIGS. 41-45.

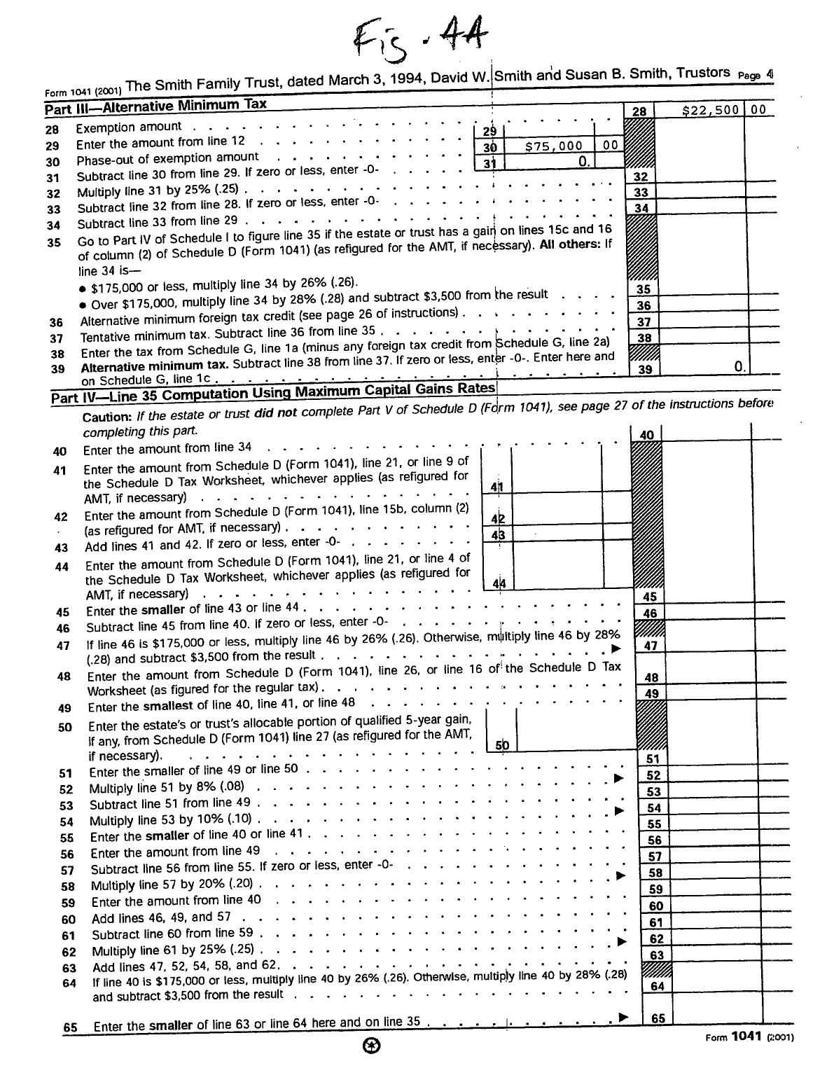

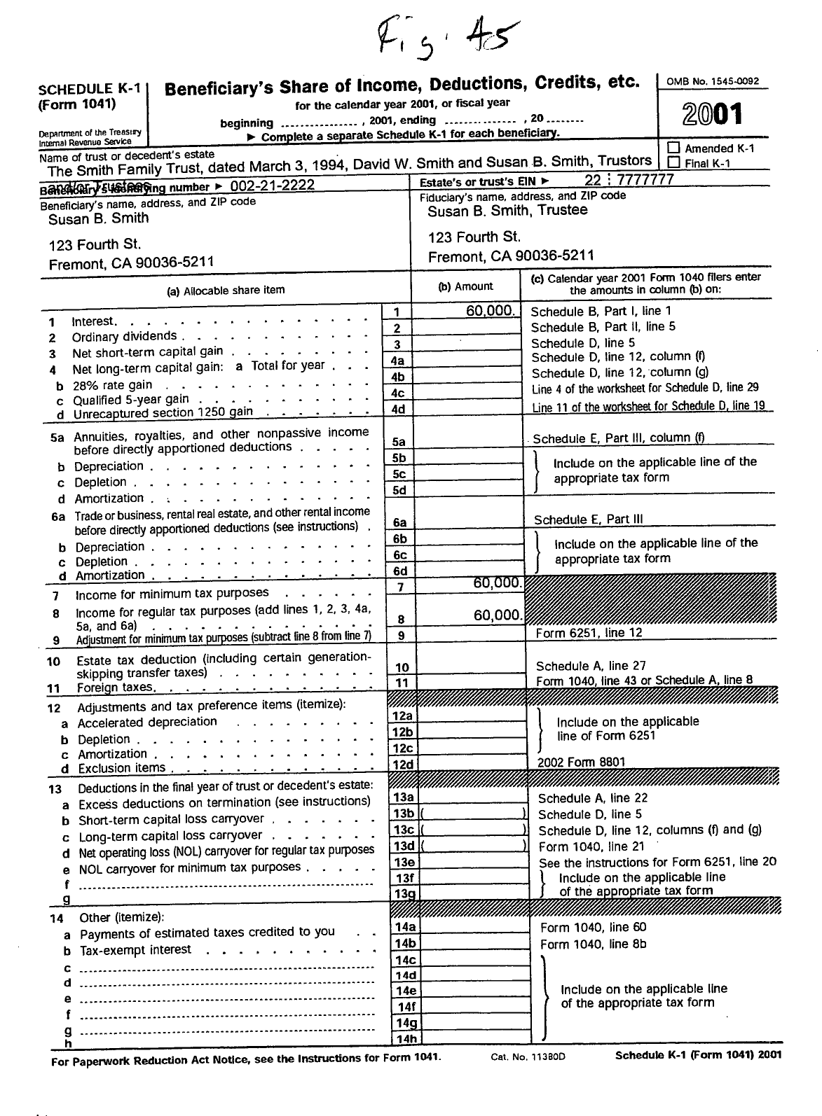

FIG. 46 shows the window that appears on the user's display when the user clicks on the “Notify Beneficiaries” button on the screen of FIG. 10. When the user clicks on the “print letters” button, the trust administration program automatically prints the beneficiary notices for the user, of the type shown as an example in FIG. 48.

FIG. 47 shows the screen that appears on the user's display when the user clicks the “Annual Reporting” button on the screen of FIG. 10.

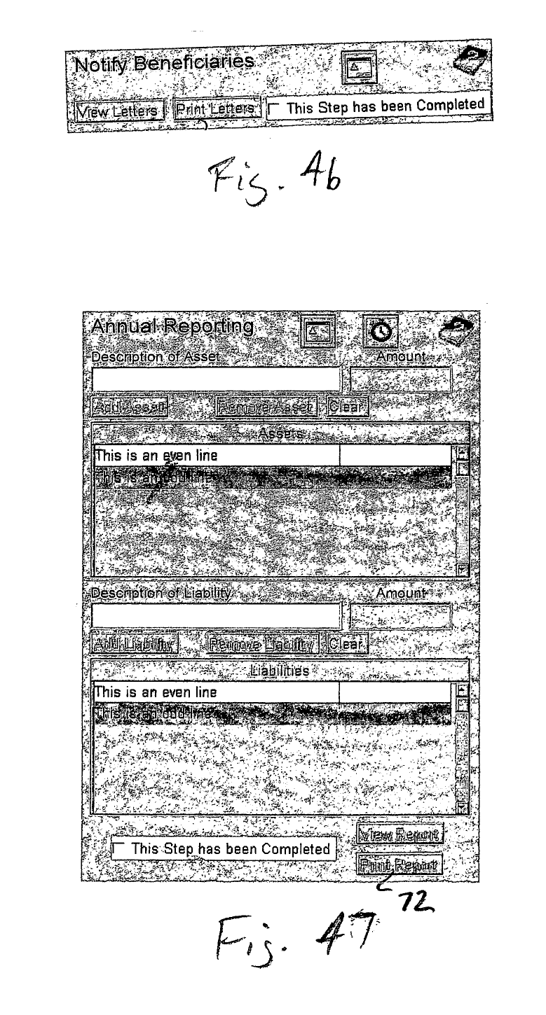

FIG. 49 shows the screen that prints when the user clicks on the “Print Report” button 72 of FIG. 47.

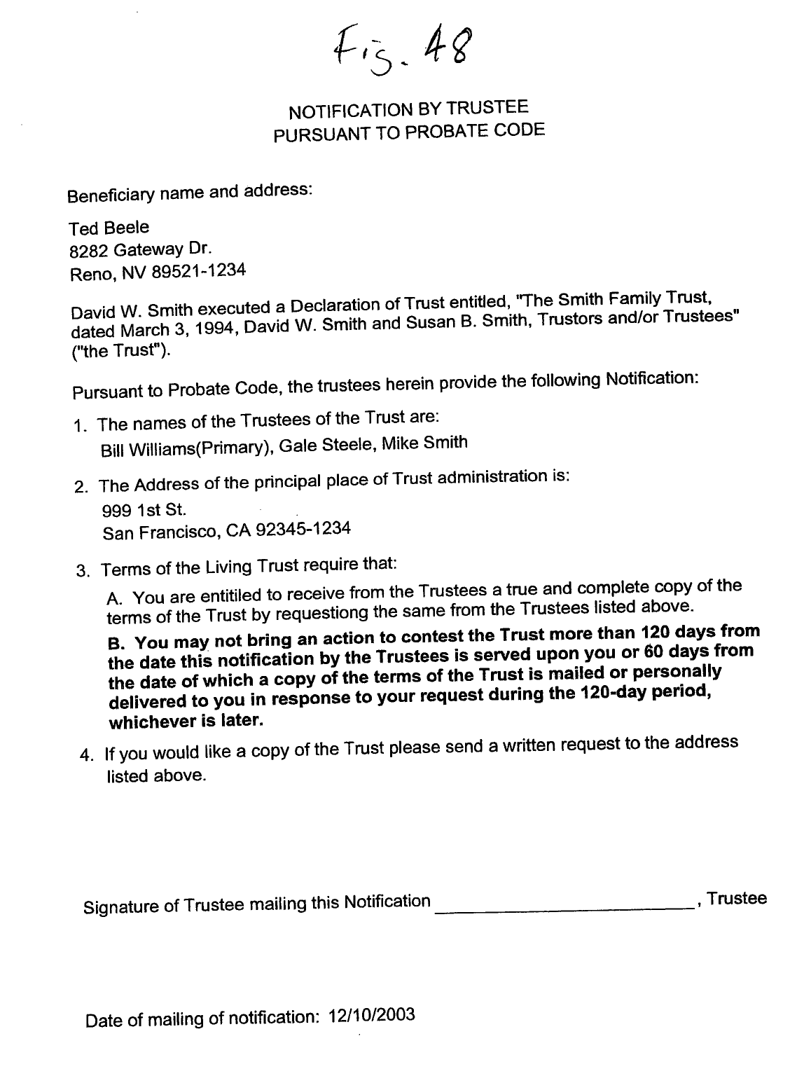

FIG. 50 shows the screen that appears when the user clicks on the “Utilities” button on the screen of FIG. 2.

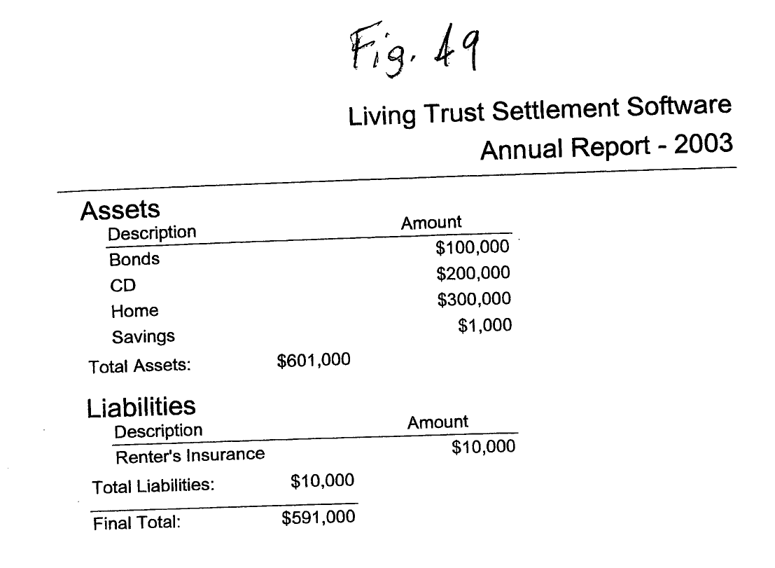

FIG. 51 shows the screen that appears when the user clicks on the “Delete A Checklist” button on the screen of FIG. 50. In the regard, the data for each checklist listed in this screen (FIG. 50) is maintained in an associated MS Access database preferably running on the computer that runs the trust administration program.

FIG. 52 shows the screen that appears when the user clicks on the “Repair A Checklist” button on the screen of FIG. 50. Through this screen the user may perform an automated repair on a corrupted checklist maintained by the associated database.

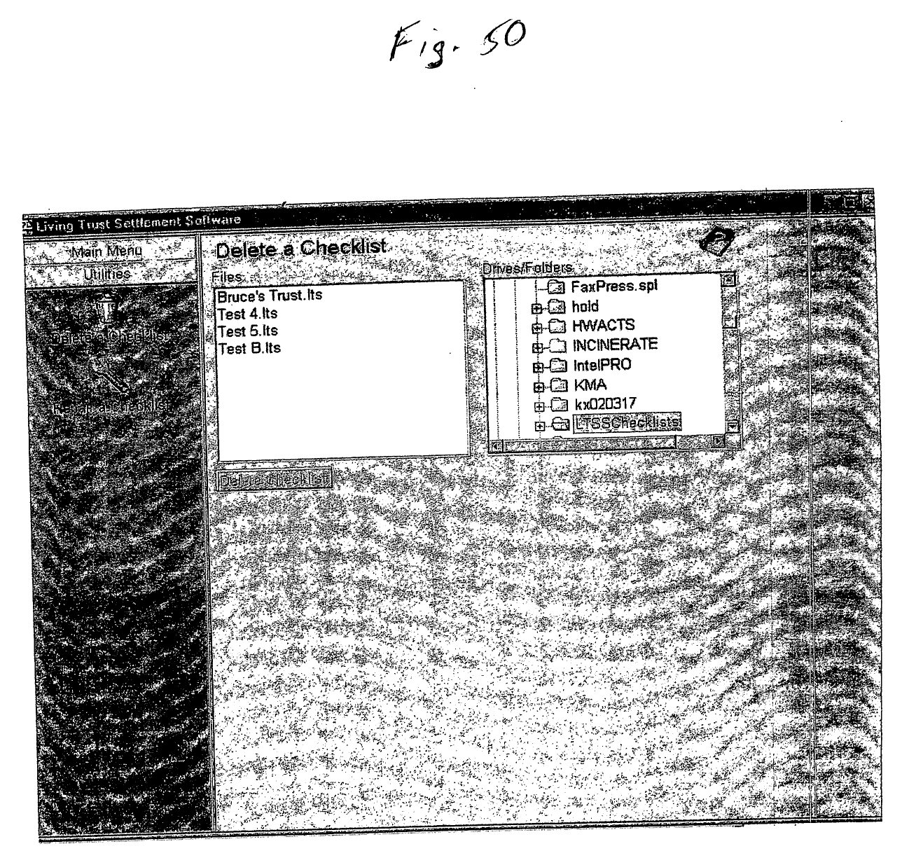

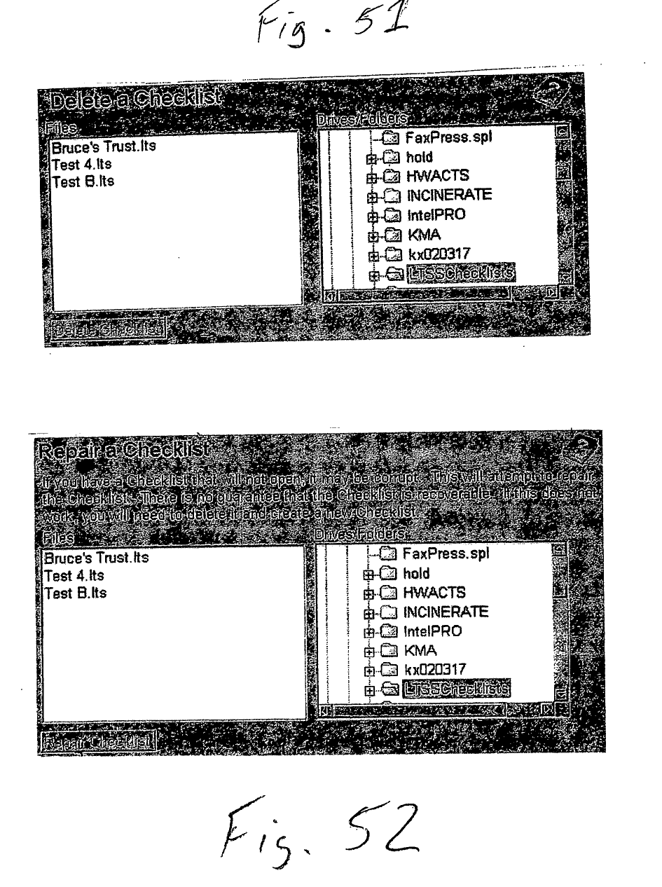

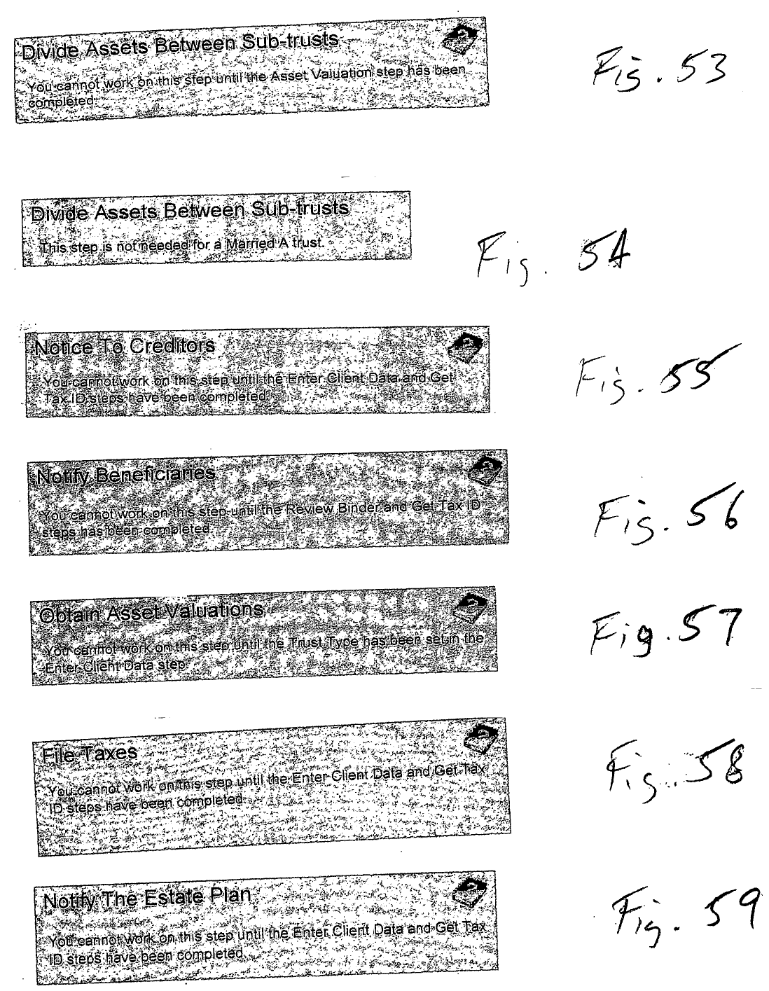

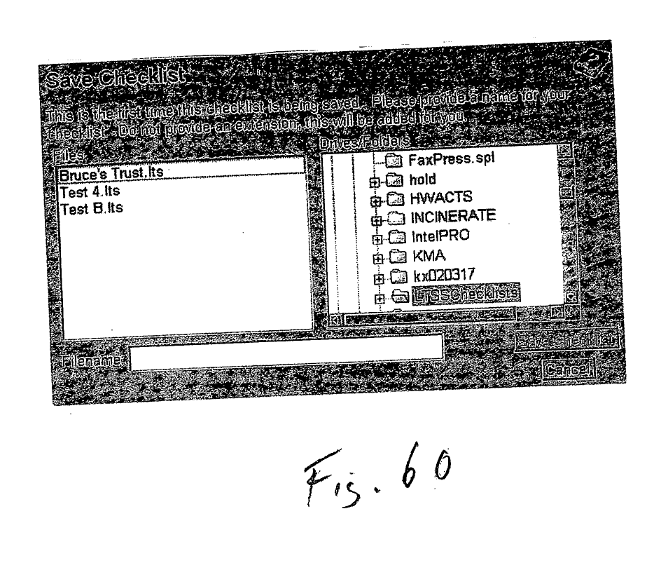

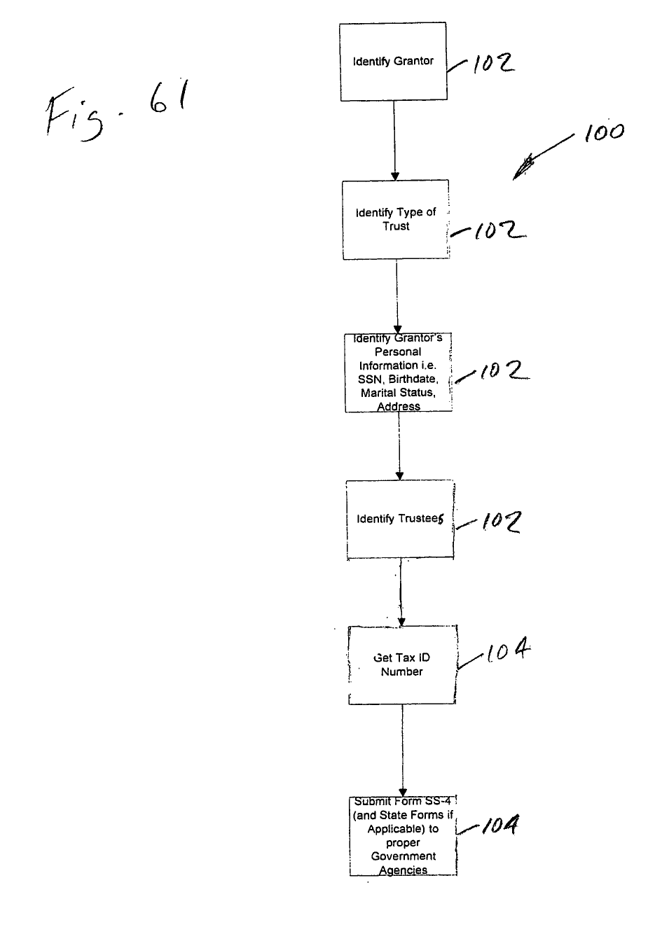

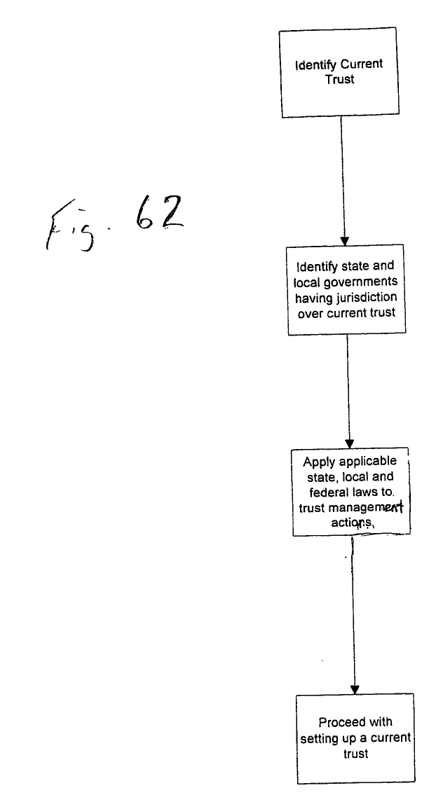

FIGS. 53-59 show error message windows that appear when the user attempts to perform activities that are not permitted or erroneous according to rules entered into the trust administration program.

FIG. 60 shows the screen that appears automatically to have the user enter a name in which to store a checklist that has been created by the user.

FIG. 61 shows the flow chart for the method of using the trust administration system to set up a trust 100. The method includes entering trust data 102 in the screens of FIGS. 9, 11, 12, 13, 21, 22, 24, 31, 33, 35, 47 and associated sub-screens as set forth above and procuring a tax identification number 104 through the screens of FIGS. 15, 16, 17, 18 as set forth above. In this regard, the screen of FIG. 33 automatically adapts to provide for entry of new assets, as opposed to modifying or editing of assets already entered in the system, depending on whether data has already been entered in the screen.

FIG. 62 shows the flow chart for the method of using the trust administration system to implement legal rules maintained and automatically applied by the system depending on the pertinent data entered in the establishing and administering one or more trusts with the system.

FIG. 63 shows the flow chart for the method if using the trust administration system to implement tax filing rules maintained and automatically applied by the system depending on the pertinent data entered in establishing and administering one or more trusts with the system. The method results in automated generation of tax filing documents 106, in connection with the screens of FIGS. 40, 41, 42, 43, 44, and 45, and automated updating of trust asset data maintained within the system 108. This tax payment method and accounting method is activated by the trust administrator by clicking on the File Taxes button 110 of FIG. 9 for an established trust in the system.

FIG. 64 shows a flow chart of the method implemented by the system to automatically cause storage of entered data as the user or administrator of the system moves from one data entry or data revision screen in the program to the next.

FIG. 65 shows the method of using the trust administration system to record income to a trust and automatically allocate income to a trust to a trust or successor trusts as applicable, through the screen such as the exemplary screen of FIG. 47 through which the user can add income to the trust assets.

FIG. 66 shows the method of using the trust administration system to identify and manage an asset transfer event such as death 118 or other or ledger update 120. In the event the transfer event is death of grantor, the administrator proceeds to the asset distribution and associated processes 121 upon death of the grantor through the pertinent buttons, generally 122, and associated sub-screens and processes of FIG. 7. In the event the transfer event is an asset change, the administrator proceeds to the pertinent allocate assets procedure 123 through button for the trust involved, e.g., 124 in FIG. 33.

FIG. 67 shows the method of using the trust administration system to automatically issue trust asset update records 126 and legally verify the update by merely printing out and signing and dating the printed updated records by the trustee 126. The user therefore need not take further action as has often been required in the past and in certain prior art systems.

Exemplary screens and printed reports for performing this method are shown in FIG. 33, via the allocate assets button 124, and FIGS. 35, 36, 37, 38, and 39. In addition, the system may be adapted to incorporate electronic signatures as at least a part of the verification and record keeping process.

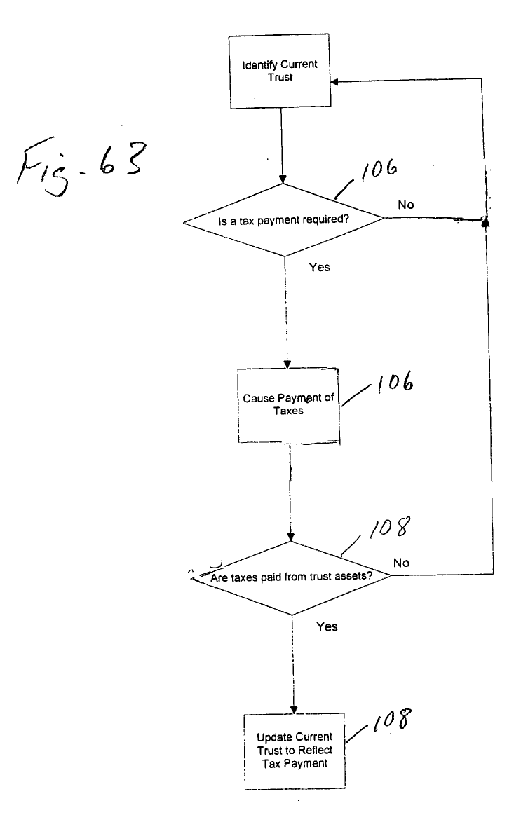

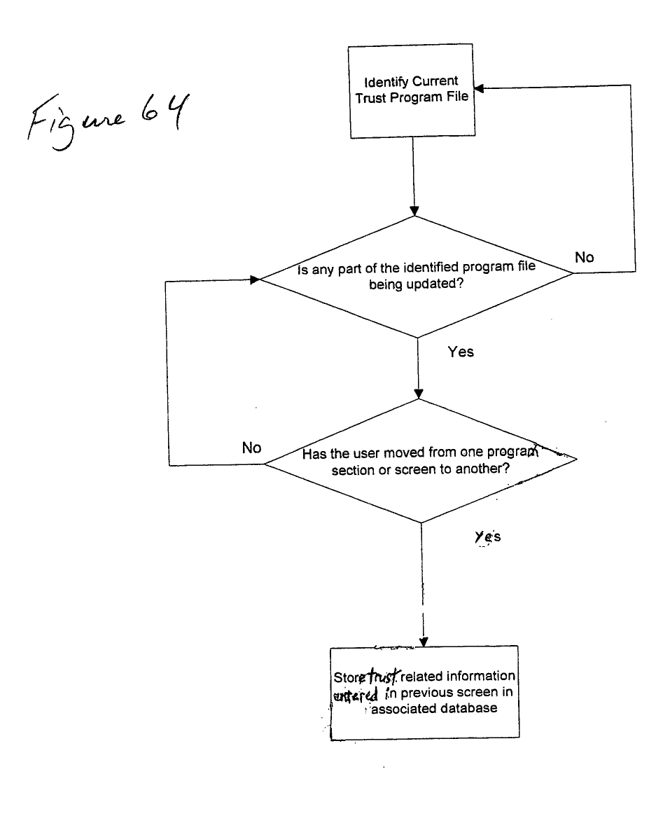

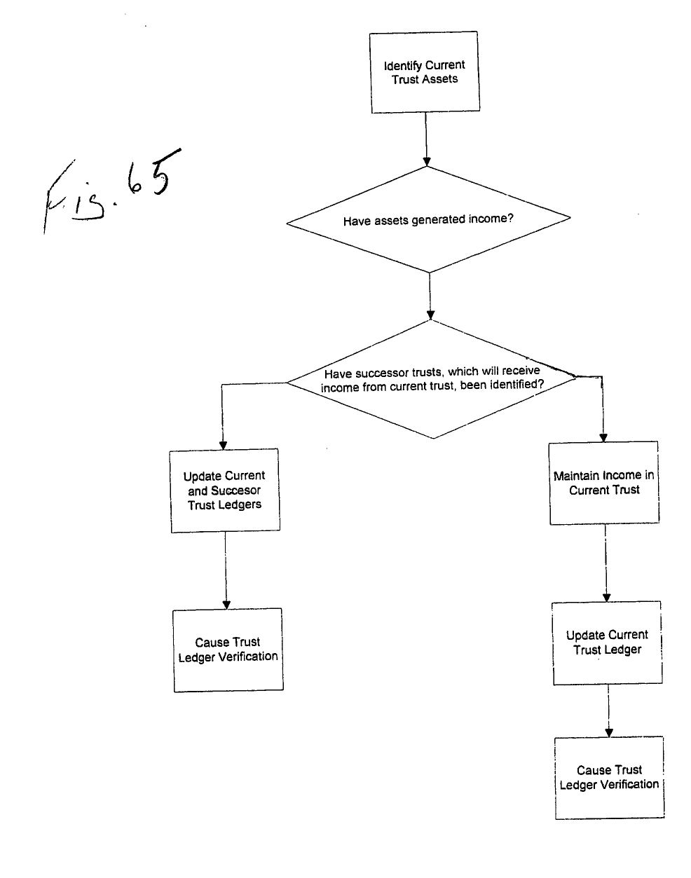

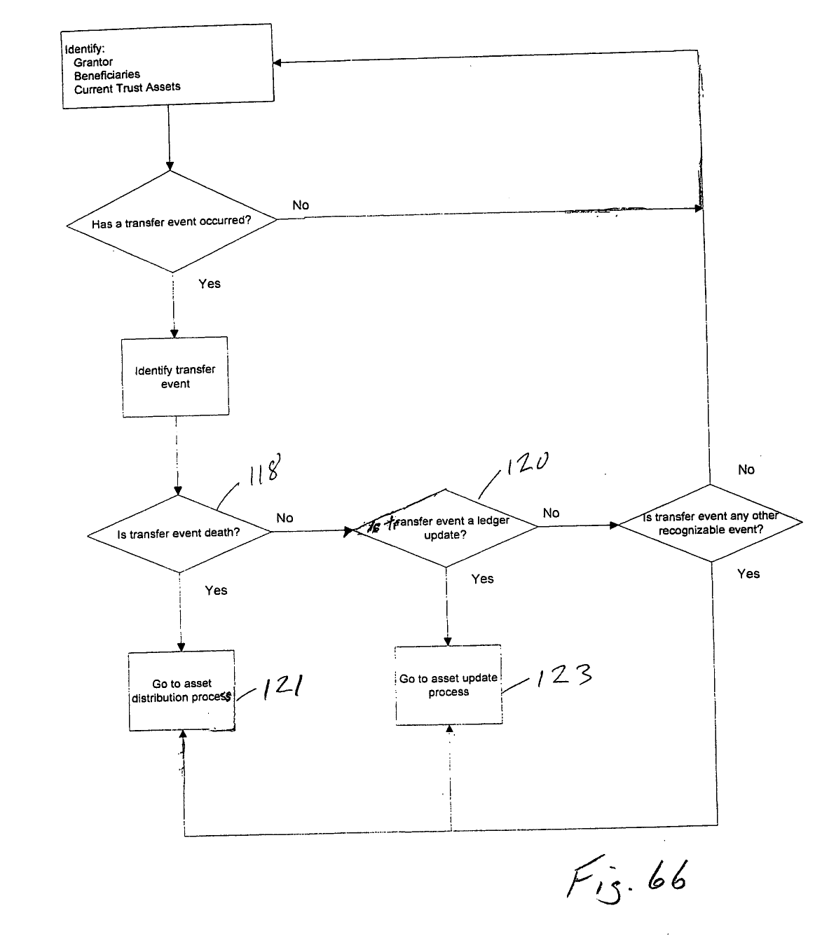

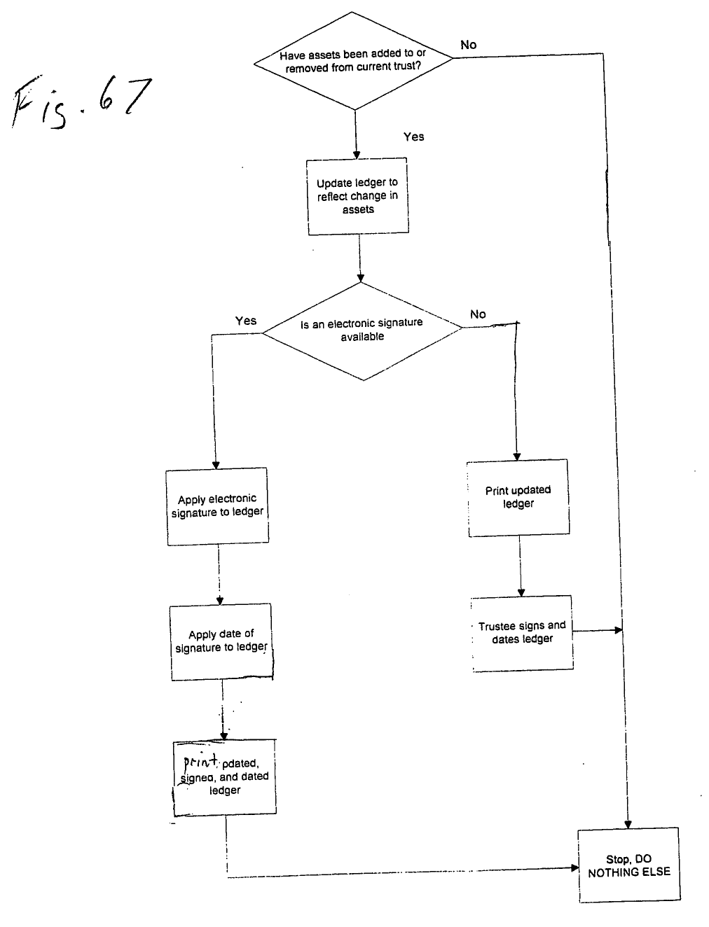

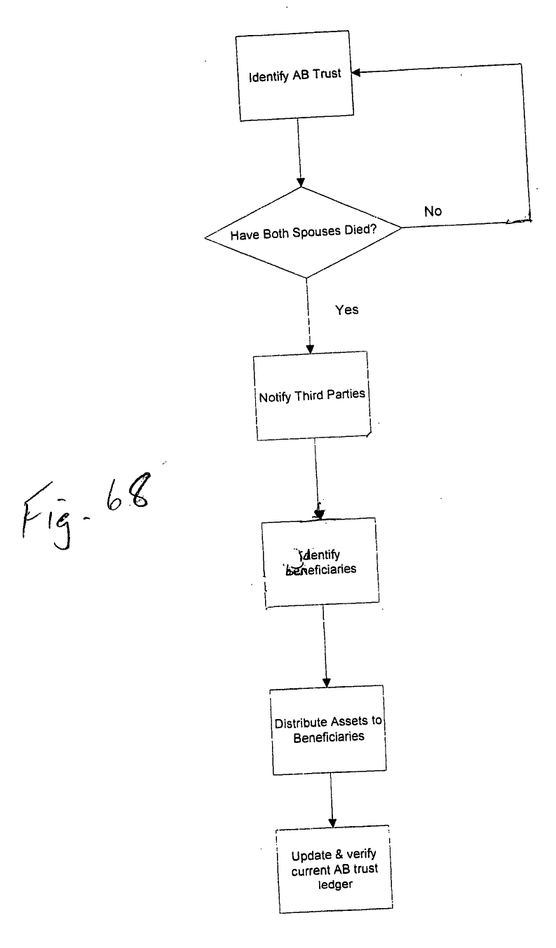

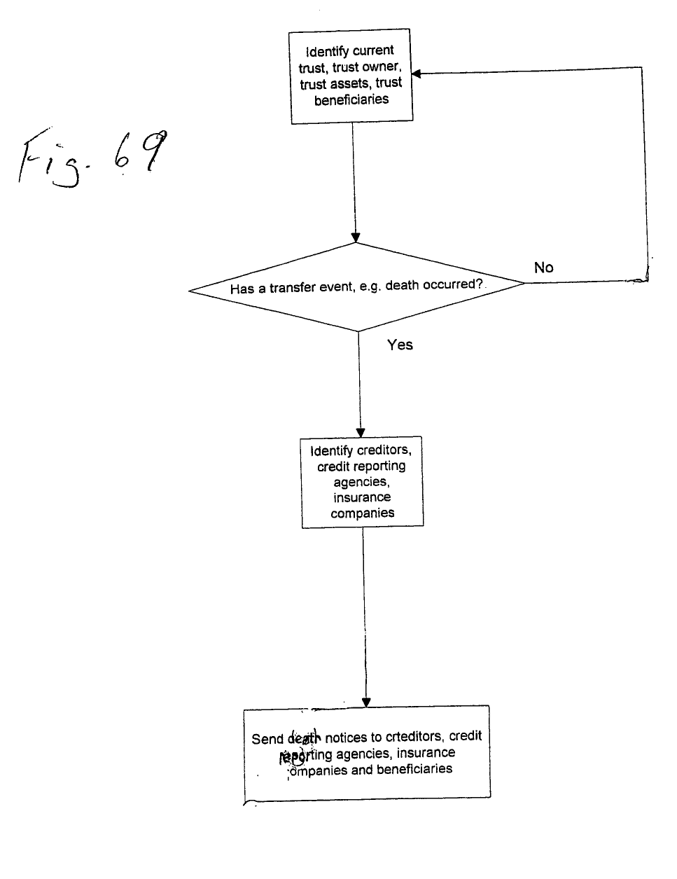

FIG. 68 shows the method of using the trust administration system to administer an AB Living Trust in connection with screens of FIGS. 7 and 9 and associated screens procured by following the steps of FIG. 65. In this regard, as assets are distributed, the system automatically updates asset data accounting in accordance with the distribution.

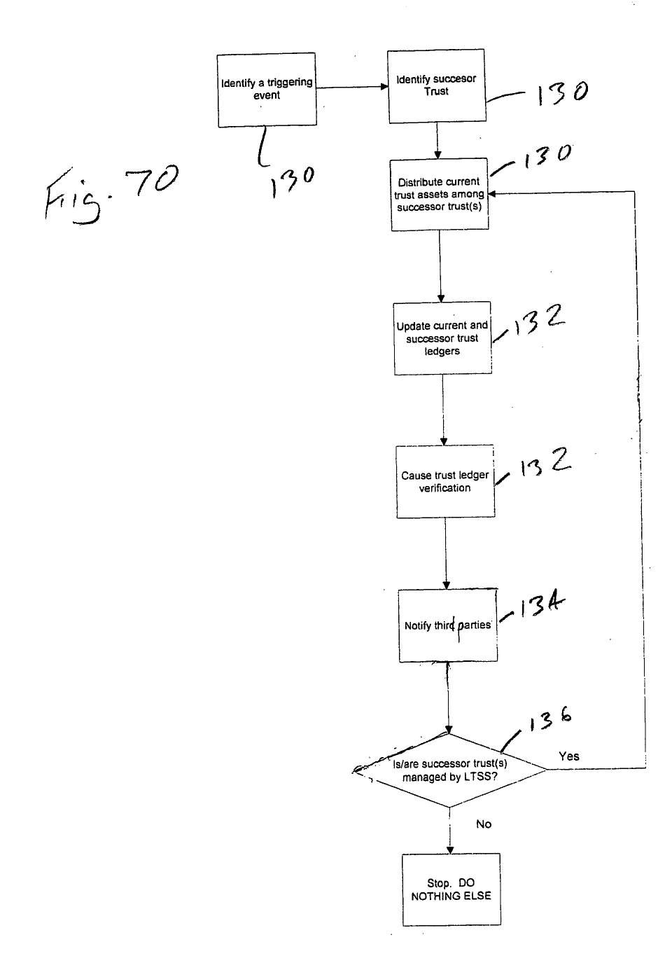

FIG. 69 shows the method of using the trust administration system for the administrator to provide third party notices upon an event requiring such notice. This third party notice method is implemented via the Notify Creditors button 112, the Notify Insurance Companies button 114, and the Notify Beneficiaries button 116 of FIGS. 9 and 10 and associated screens and steps identified above.

FIG. 70 shows the method of using the trust administration system for the administrator to identify an event for distribution of assets to a successor trust 130, updating the ledger for the respective trusts and verifying the ledgers as set forth above 132, and issuing notice to pertinent third parties as explained above 134. Pertinent third parties may include a third party trust administration records keeper, and supplemental trust docket and trust law change reporting system or business, such as identified as “LTSS” and process 136 in this FIG. 70.

The trust administration system of FIGS. 1-60, and as operated in accordance with FIGS. 61-70, runs on a Microsoft Windows® operating system, functions on networks or stand-alone personal computers, and is compatible with all PC-compatible printers. The system of FIGS. 1-60 is preferably written in Microsoft Visual Basic 6.0 and calls Active-X controls in run-time. System copy protection software is preferably implemented with the Software Key Licensing System, by Concept Software, Inc. The system may be adapted or altered, however, for use on other operating systems, in other languages, and with other copy protection schemes.

The trust administration system or components of it may be used in conjunction with various types of businesses, including that identified in the system as “The Estate Plan.” This latter business may provide trust forms and information, software, other systems, and updates of any such information or products to trust administrators for a fee as well as provide supplemental record keeping, docketing, and issuance of legal or other trust related or administration notices or information, for a fee if desired, as noted above.

Other businesses may also derive revenue from use of the trust administration system or components thereof. For example, a trust administrator may utilize the system and receive revenue for doing so, or a business such as a bank or other financial services company may utilize the program to provide services to customers, such as, for example but without limitation, those who may deposit funds or assets with the entity for management by the entity in managing associated trusts or other accounts or portfolios.

It is to be understood that the foregoing is a detailed description of the preferred embodiments. The scope of the present invention is not to be limited thereby.

1. An automated estate plan system of the type useable to implement and manage a trust by procuring estate planning data from a user for manipulation of the estate planning data by a computing apparatus, the automated estate plan system comprising:
an estate plan management system operable on a computing system and including an estate plan database system, asset identification data maintained in association with the estate plan database system, and a ledger generating application running on the computing system and automatedly providing one or more verifiable trust asset ledgers;
whereby trust assets may be lawfully transferred out of the trust via the one or more verifiable trust asset ledgers when verified without need for further asset transfer activity.

2. The automated estate plan system of claim 1 further including grantor and beneficiary identification data maintained in association with the estate plan database system.

3. The automated estate plan system of claim 2 further comprised of triggering event identification information, whereby a triggering event causes alteration of assets of the trust.

4. The automated estate plan system of claim 1 wherein the one or more verifiable trust asset ledgers comprise at least one hard original.

5. The automated estate plan system of claim 1 further including income data information maintained in association with the estate plan database system.

6. The automated estate plan system of claim 1 further including a trust law information library, wherein the library is comprised of information for legally implementing the trust.

7. The automated estate plan system of claim 2 further including a trust law information library, wherein the library is comprised of information for legally managing the trust.

8. The automated estate plan system of claim 6 wherein the trust law information library contains tax law information.

9. The automated estate plan system of claim 7 wherein the trust law information library contains tax law information.

10. The automated estate plan system of claim 1 wherein the estate plan database system is in data-exchange communication with a user interface.

11. The automated estate plan system of claim 1 wherein, via the estate plan system database system, an item of data entry is automatically applied to a plurality of data entry fields.

12. An automated estate plan system of the type useable to implement at least a first trust and a second trust by procuring estate planning data from a user for manipulation of the estate planning data by a computing apparatus, the automated estate plan system comprising in combination:
an estate plan management system runnable on the computing system and including a user interface, an estate plan database system in data-exchange communication with the user interface, asset identification data maintained in association with the estate plan database system, first and second trust asset allocation data maintained in association with the estate plan database system, and a first and second trust asset ledger generating application running on the computing system, and a first and second trust asset ledger generating application running on the computing system and automatedly providing one or more verifiable first and second trust asset ledgers;
whereby first and second trust assets may be lawfully transferred to the first and second trusts respectively via the one or more verifiable first and second trust asset ledgers when verified and without need for further asset transfer activity.

13. The automated estate plan system of claim 1 wherein the verification comprises an asset trustee's signature and dating of one or more among the one or more verifiable first and second trust asset ledgers.

14. The automated estate plan system of claim 1 wherein the first trust comprises an A living trust and the second trust comprises a B living trust.

15. The automated estate plan system of claim 14 wherein the first trust comprises an A living trust and the second trust comprises a B living trust.

16. The automated estate plan system of claim 14 of the type also useable to also implement a third trust and further comprising third trust allocation data maintained in association with the estate plan database system and a third trust asset ledger generating application.

17. An automated estate plan system of the type useable to implement and manage a trust, the automated estate plan system comprising:
an estate plan management system runnable on a computing system and including an estate plan database system, asset identification data maintained in association with the estate plan database system, and a ledger generating application running on the computing system providing one or more verifiable trust asset ledgers;
whereby trust assets may be lawfully transferred out of the trust via the one or more verifiable trust asset ledgers when verified without need for further asset transfer activity; and
an automatic data storage application whereby the asset identification and trust asset information is automatically stored.

18. The automated estate plan system of claim 1 wherein the automatic storage application is triggerable upon user activation of a command to move from a data entry screen of the estate plan management system.
